(19) United States
(12) Patent Application Publication
(10) Pub. No.: US 2023/0342496 A1
(43) Pub. Date: Oct. 26, 2023

(54) TRUST BROKERING AND SECURE INFORMATION CONTAINER MIGRATION

(71) Applicants: Kshitij Arun Doshi, Tempe, AZ (US); Ned M. Smith, Beaverton, OR (US); Sunil Cheruvu, Tempe, AZ (US); Rajesh Poornachandran, Portland, OR (US)

(72) Inventors: Kshitij Arun Doshi, Tempe, AZ (US); Ned M. Smith, Beaverton, OR (US); Sunil Cheruvu, Tempe, AZ (US); Rajesh Poornachandran, Portland, OR (US)

(21) Appl. No.: 18/216,927

(22) Filed: Jun. 30, 2023

(51) Int. Cl. G06F 21/62; G06F 21/44

(52) U.S. Cl. CPC G06F 21/6281; G06F 21/44

(57) ABSTRACT

A system for trust brokering as a service includes an edge computing node and a trust brokering service edge computing device. The trust brokering service edge computing device receives a computing workload request from an application configured to process secure data and identifies a set of security requirements associated with the request. The device also identifies a security feature present in the set of security requirements but not provided by the edge computing node. To address this, the device generates an application execution environment that includes a secure plugin providing the security feature and a virtual device representing the edge computing node. The computing workload request is then executed at the application execution environment, providing a secure and efficient solution for trust brokering as a service.

### BACKGROUND

Public cloud computing environments and on-premises data centers may be used to deploy networked, general-purpose servers equipped with numerous (e.g., hundreds, thousands) of high-throughput cores to host varying types of computing applications. These computing applications may include applications that are a combination of computationally intensive, memory-operations intensive, storage-operations intensive, and networking intensive. These computing applications may also include applications that are security sensitive, such as applications that have heightened encryption requirements.

In edge computing environments, particularly in mobile or other power-limited far edge computing environments, data-producing and data-serving computing devices (e.g., sensors, loggers, data acquisition systems) may not be equipped with mid-range or high-performance servers. Even if the edge computing device has a traditional central processing unit (CPU) available, that CPU is often be part of a data appliance, sensor appliance, software-defined networking (SDN) element, or other appliance dedicated to a particular type of computing function. The edge computing device may function with such a CPU or other processor when computations on the edge are primarily focused on locally available data (e.g., in a home) or on a limited volume of data at a time (e.g., smartphone on-board CPU for low latency and efficiency). However, as edge computing applications use increasingly computationally intensive applications (e.g., generative Artificial Intelligence (GAI)) executed at the edge computing device, it may be impractical to transfer all necessary data between the device and cloud servers or backhauled through CDNs.

Edge computing environments may also have complex security requirements. Edge device security may require data isolation and data filtering across the edge network at low latency, where computing services may move the most complex computations to be at edge co-located (CoLo) micro-datacenters (uDCs), and where data may be received from “headless” systems (e.g., systems without a general-purpose software stack). Such edge network configurations may have complex and dynamic requirements for access-control, encryption, integrity, auditing, confidentiality, and other functionality.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating a trust brokering service architecture, according to an embodiment.

FIG. 2 is a block diagram illustrating a security gap analysis, according to an embodiment.

FIG. 3 is a block diagram illustrating a one-sided adapter, according to an embodiment.

FIG. 4 is a block diagram illustrating a two-sided adapter, according to an embodiment.

FIG. 5 is a block diagram illustrating a service migration manager architecture, according to an embodiment.

FIG. 6 is a block diagram illustrating a CaaS provider architecture, according to an embodiment.

FIG. 7 is a block diagram illustrating a Kafka architecture, according to an embodiment.

FIG. 8 is a block diagram illustrating a Container as a Service (CaaS) provider architecture, according to an embodiment.

FIG. 9 is a flow diagram illustrating elastic workload partitioning and Secure Information Container (SIC) lifecycle management method, according to an embodiment.

FIG. 10 is a block diagram illustrating a secure container migration flow method, according to an embodiment.

FIG. 11 is a flow diagram illustrating a method for secure and attestable functions-as-a-service, according to an embodiment.

FIGS. 12A and 12B provide an overview of example components within a computing device in an edge computing system, according to an embodiment.

FIG. 13 is a block diagram showing an overview of a configuration for edge computing, according to an embodiment.

FIG. 14 illustrates operational layers among endpoints, an edge cloud, and cloud computing environments, according to an embodiment.

FIG. 15 illustrates an example approach for networking and services in an edge computing system, according to an embodiment.

FIG. 16 illustrates an example software distribution platform to distribute software, according to an embodiment; and.

FIG. 17 depicts an example of an Infrastructure Processing Unit (IPU), according to an embodiment.

### DETAILED DESCRIPTION

Edge computing devices may be improved using Trust Brokering as a Service (TBaaS), which provides trust brokering services that provides the ability to implement active trust according to varying security requirements of different workload, such as by permit asymmetric arrangements for executing security-related computations. TBaaS provides various advantages, including secure migration of a workload between edge computing nodes. Each workload may include different subcomponents, each with an associated set of security requirements. The TBaaS provides an improved ability to conform to security requirements within scalable (e.g., elastic) cloud computing environments (e.g., security sensitive services provided by elastic cloud-to-edge computing environments, and when cloud computing applications are refactored into other environments (e.g., restructuring existing cloud application code to run as a Function-as-a-Service (FaaS) without changing the application behavior). When elastic workload (workload) applications are refactored into microservices or FaaS functions, the TBaaS may be used to migrate refactored units of data or computation to improve or optimize application performance in the newly created environment, such as optimizing for latency, throughput, cost, availability, elasticity of resource consumption, and scalability.

If the security mandates of one subcomponent of a workload cannot be met at a first computing node, instead of moving the entire workload to another computing node, the TBaaS may be used to refactor (e.g., decompose) the workload and reallocate the subcomponent to another node. This reallocation may include proxying that subcomponent's accesses to data with the help of TBaaS through data filtering, encoding, and transmutation, so that the security requirements are fulfilled. If the subcomponent cannot be proxied, and if that subcomponent's security requirements cannot be fulfilled at the first node, then the TBaaS may migrate the subcomponent to a second node. The TBaaS may decompose the workload to divide the workload into subcomponents that can be executed on different nodes, collect computing results from the nodes, and combine the results into a final workload computing result.

This TBaaS may provide trust management services for various edge computing nodes, and may be used to manage edge computing nodes in a decentralized fashion. In an example, some edge nodes may not have sufficient computing capabilities for that node to participate fully in an elastic trust establishment, such as passive edge computing nodes (e.g., storage appliance, AI appliance, memory pool, etc.). Using TBaaS, a passive node may be mastered by the trust brokering service. This mastering of a passive node reconfigures the passive node dynamically to operate as configured by the TBaaS, and logically redirects any requests targeting the passive node to the trust brokering service. These requests may include a request for reconfiguring a node as a data source or as a data sink (e.g., data destination). These passive nodes may include nodes with or without CPU elements, including passive nodes with CPUs that run embedded software or dedicated software.

TBaaS may allow the passive node to participate in various tailored arrangements using these trust management services. For some tailored arrangements, the TBaaS may configure a passive node to send or receive sensitive data (e.g., raw data, derivations from the data) to the mastering service. In other tailored arrangements, the TBaaS may configured a passive node to be a direct peer to other edge nodes, which may improve the ability of the edge node network to provide data-intensive and latency-sensitive services.

The TBaaS may receive metadata describing the security requirements of a workload (e.g., application security requirements, service security requirements). Using this metadata, the TBaaS may reconfigure the passive node's data sourcing or sinking operations to be performed as needed for the workload. The TBaaS also reconfigures the passive node such that any security related transformations are performed within the TBaaS, while providing improved security by exchanging only uninterpretable data between the passive node and the TBaaS.

The TBaaS also provides technical improvements for latency-critical or otherwise overhead-sensitive operations. In an example, the TBaaS may avoid sending data to the TBaaS by arranging to have plugins run locally at a peer application service node to perform the needed transformations. The TBaaS may also cause a passive node to implement various security features (e.g., built-in encryption, built-in integrity signatures, etc.). The TBaaS may combine those built-in features with TBaaS-provided additional or incremental transformations, which may provide the level of data protection that is specified by the metadata. In an example, the TBaaS may filter personally identifiable information (PII) out of data and store the PII separately under a higher level of security. This avoids the need to transform all data to provide a requisite level of security, which may substantially reduce computation requirements for large data sets.

This TBaaS may provide improved functionality for passive nodes or other smart components. The TBaaS provides the ability for remote dedicated appliance functions (e.g., internet Small Computer System Interface (iSCSI) storage devices) to participate in flexible yet robust security arrangements while providing data storage, data caching, data filtering, and data furnishing. The TBaaS provides the ability for lower-powered mass-storage devices to be placed in far-edge locations and within close proximity (e.g., a few microseconds for data movements) of rich sensor hubs, while maintaining the ability of the storage devices to be securely bridged to applications that may run in a core network at far-edge locations, near-edge locations, or in CoLo facilities.

In the following description, for purposes of explanation, numerous specific details are set forth to provide a thorough understanding of some example embodiments. It will be evident, however, to one skilled in the art that the present disclosure may be practiced without these specific details.

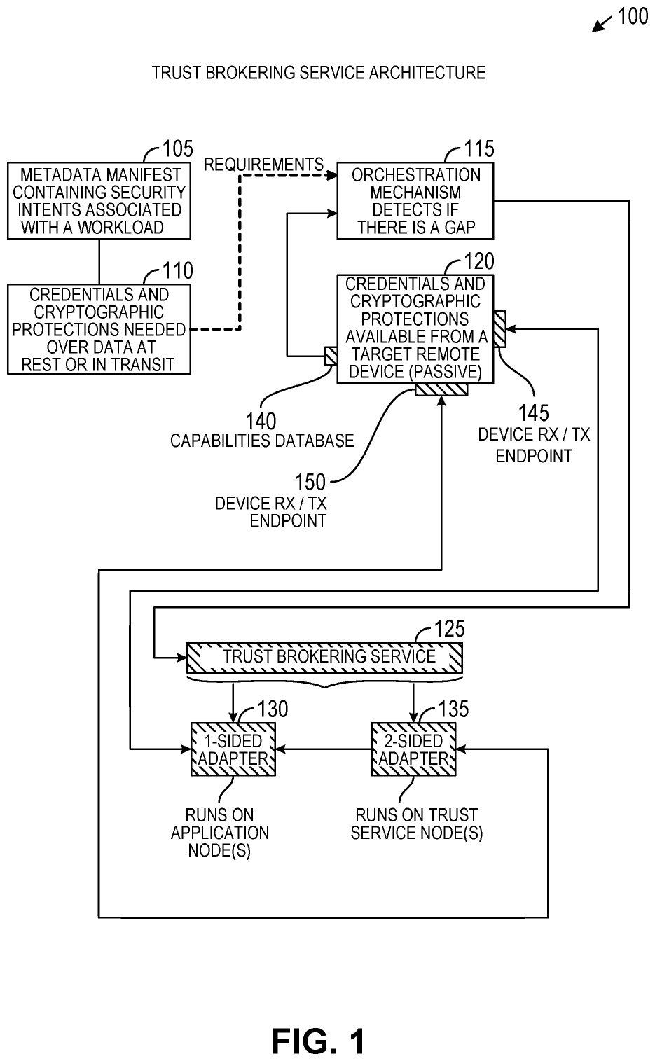

FIG. 1 is a block diagram illustrating a trust brokering service architecture 100, according to an embodiment. Architecture 100 may be used to implement TBaaS, including allocating a given workload to one or more edge nodes. The TBaaS implementation may be based on a metadata manifest 105, which may contain security intents associated with given workload. Based on the metadata manifest 105, architecture 100 may determine security requirements 110. The security requirements 110 may specify credentials and cryptographic protections needed for data at rest or in transit.

An orchestration mechanism 115 detects if there is a gap between the security requirements for a workload and the capabilities of a target remote device (e.g., passive edge node). The orchestration mechanism 115 may identify this gap based on a comparison between received security requirements 110 and received credentials and cryptographic protections 120 available from a target remote device. In an example, the orchestration mechanism 115 may retrieve the credentials and cryptographic protections 120 by querying a capabilities database 140.

A trust brokering service 125 may be used to broker trust between a workload and a target device, such as to remediate any security gaps. The trust brokering service 125 may receive data describing a security gap from the orchestration mechanism 115. Based on this security gap data, the trust brokering service 125 may determine whether to implement a one-sided adapter 130 that runs on one or more application nodes or a two-sided adapter 135 that runs on one or more trust service nodes.

A one-sided adapter 130 may be implemented when the workload is adapted to the capabilities of the device, and may include receiving cryptographic protections 120 via a first endpoint 145. A two-sided adapter 135 may be implemented when both the workload and device are adapted to enforce cryptographic protections 120, which may be received via a second endpoint 150.

The trust brokering service 125 may configure data encryption and access control such that the burden for doing so is asymmetric. This asymmetric implementation may include configuring a specialized node to receive and access data in a manner that is most efficient for the specialized node. This asymmetric implementation may also include configuring peers of the specialized node to implement proxying services that are installed at the peer nodes. This use of proxies may enable the requested confidentiality and authentication checks, while preventing the proxies from interfering with or altering any authentication checks. The trust brokering service 125 may also analyze the proxies to verify that the proxies have not been infected with malware, such as using period scans, chain of trust verifications, challenge-response verifications, or other verifications.

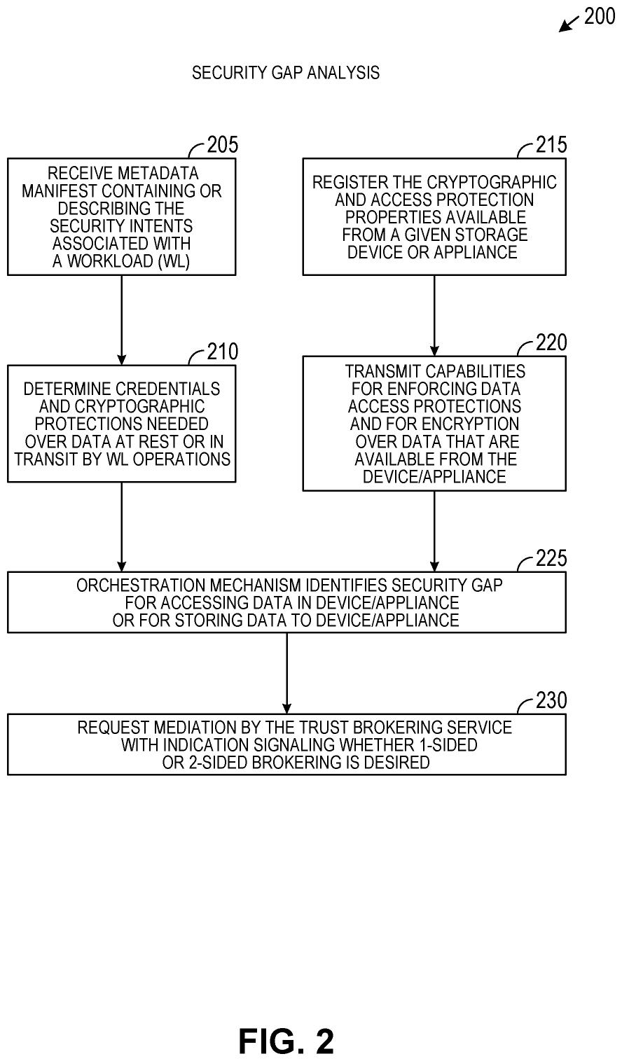

The trust brokering service 125 may be used to match (e.g., bind) a workload to edge computing nodes based on various capabilities, such as node performance, availability, resiliency, security, trust, and other node characteristics. This binding may be applied dynamically so that an elastic workload may commission or decommission according to elastic workload conditions, such as by decomposing the workload into sub-workloads that run in parallel for a portion of the workload execution sequence. The determination as to whether to implement a one-sided adapter 130 or two-sided adapter 135 is described with respect to FIG. 2.

FIG. 2 is a block diagram illustrating a security gap analysis 200, according to an embodiment. The security gap analysis 200 may be used by a trust brokering service, such as trust brokering service 125. A metadata manifest 205 may be received, where the metadata manifest 205 may contain or describe security intents associated with a workload. The workload security intents may describe various security requirements associated with the workload, such as data availability, user authentication, user authorization, data confidentiality, or data integrity. Based on these security intents, security gap analysis 200 may determine credentials and cryptographic protections 210 for data used in the workload, including credentials and cryptographic protections needed for data at rest or data in transit.

In parallel with the analysis of the metadata manifest 205, the security gap analysis 200 may register the cryptographic and access protection properties 215 available from a given edge device (e.g., edge storage device, edge appliance). These properties may include cryptographic properties and access protection properties associated with that edge device, such as cryptographic, access control, integrity verification capabilities and certificates, device measurements, immutable tokens, and other edge device properties. Based on these cryptographic and access protection properties 215, security gap analysis 200 may transmit access protection enforcement capabilities 220 of the edge device. These access protection enforcement capabilities 220 may describe capabilities of the edge device, such as device capabilities for enforcing data access protections and for capabilities encryption over data that are available from the edge device.

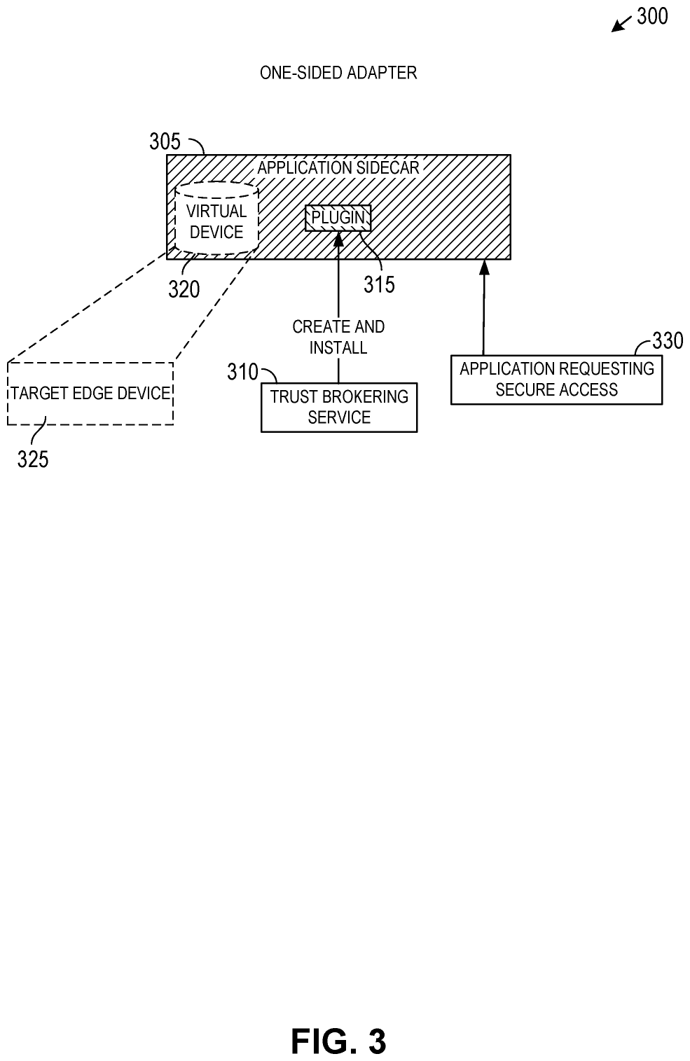

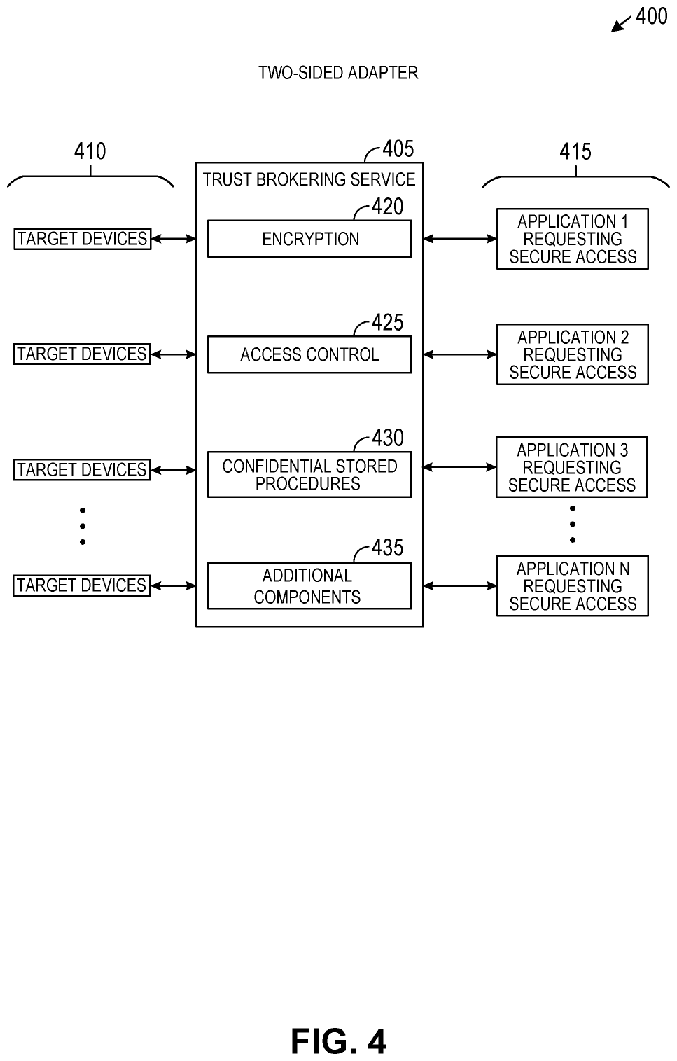

An orchestration mechanism may be used to identify a security gap 225. The security gap 225 may include identifying one or more cryptographic protections 210 that cannot be satisfied fully based on the access protection enforcement capabilities 220 of the edge device. In an example, the security gap 225 may include security gaps in edge device confidentiality and data localization requirements, such as requirements for accessing data in the edge device or for storing data to the edge device. Using this identified security gap 225, the orchestration mechanism may submit a mediation request 230 to a trust brokering service. The trust brokering service may use the mediation request 230 to adapt (e.g., bridge the workload security to the security capabilities of available edge devices. This mediation request 230 may include identifying whether one-sided or two-sided mediation is requested. A one-sided adapter is shown and described with respect to FIG. 3, and a two-sided adapter is shown and described with respect to FIG. 4.

FIG. 3 is a block diagram illustrating a one-sided adapter 300, according to an embodiment. The one-sided adapter 300 may be implemented within an application sidecar 305 on a single edge device. The implementation on a single edge device may be used to satisfy various workload requirements for direct access, such as access requirements for low latency, high performance, or low overhead.

A trust brokering service 310 may create and install a plugin 315 on the application sidecar 305. The plugin 315 may be used to create a virtual device 320, where the virtual device 320 provides virtual access to a virtual target edge device 325. The virtual target edge device 325 may be configured to satisfy the required security and other target edge device functionality. After the virtual device 320 is created and configured, an application requesting secure access 330 may communicate through the application sidecar 305 and access the target edge device 325 through the virtual device 320. The virtual device 320 may include a virtual execution environment, which may include a virtual machine (VM) or a virtual container.

The trust brokering service 310 may dynamically compile security policies and other functionality into the plugin 315, and may allocate local memory and storage from the infrastructure of the application sidecar 305. This enables the virtual device 320 to facilitate memory-optimized access (e.g., using a caching engine) to performance-critical services. The resulting configuration in the application sidecar 305 may provide transparent use of all needed security protocols to the application requesting secure access 330 via the plugin 315 and the virtual device 320.

The virtual device 320 may provide customized access of the contents of the virtual target edge device 325 to the application requesting secure access 330, such as providing access to a subset of the functionality of the virtual target edge device 325. The virtual device 320 may treat the virtual target edge device 325 as a raw set of storage blocks and store data in an encrypted format. The plugin 315 may further improve security by configuring and using an integrity protected communication channel between the target device 325 and the virtual device 320. The plugin 315 may be constructed and installed dynamically by the trust brokering service 310, and may be removed later upon a request to close the device.

FIG. 4 is a block diagram illustrating a two-sided adapter 400, according to an embodiment. The trust brokering service 405 may be used to provide a two-sided trust-brokered mediation between a group of target devices 410 (e.g., target edge devices, target edge appliances) and a group of applications 415 requesting secure access. The trust brokering service 405 may be used to provide a virtualized view of edge computing devices and edge computing data that meet the individual security requirements for each application.

The trust brokering service 405 may include various components to provide the virtualized view. The trust brokering service 405 may include an encryption component 420, which may be used by the trust brokering service 405 to encrypt data stored on the target devices 410. Similarly, an access control component 425 may be used to enforce access control policies on the target devices 410, and a confidential stored procedure component 430 may be used to provide confidential storage of one or more application procedures. The trust brokering service 405 may include additional components 435, such as to provide replication functionality, data integrity functionality or other functionality. The trust brokering service 405 may also be used to provide flexible data sharing arrangements, such as producer/consumer arrangements, shared/private arrangements, read-only/read-write arrangements, synchronous/asynchronous arrangements, or other data sharing arrangements.

The trust brokering service 405 may configure the target devices 410 to enter an inactive mode (e.g., sleep mode), such as to reduce or minimize power consumption. When a device is in its inactive mode, the device may be unavailable to various applications. The trust brokering service 405 may provide a device directory or device proxy node to represent each of the target devices 410, which may be used by the trust brokering service 405 or the group of applications 415 to determine each node's capabilities, services, data management, and other node features. A proxy node may be used to initiate a wake-up service for inactive nodes. In an example, the wake-up service may be used to determine whether a proxy service request can be serviced by the proxy node or if the inactive node should be activated (e.g., woken up) to perform the service request. The proxy node may also be used to represent trust properties of the inactive node, and may cache attestation information (e.g., an attestation result) that may be replayed as part of a node attestation request. This may be used to enable an inactive node to remain inactive to conserve energy until it is appropriate to activate that inactive node. In an example, a hardware state variable may be used to tracks system updates or state change events that have occurred while the node has been inactive. This hardware state variable may be shared with a proxy node upon activation of an inactive node, such as to determine if the cached attestation result should be refreshed before exposing the inactive node to a collaborator node that has been continually active.

The trust brokering service 405 may use a zero trust configuration to provide secure access between target devices 410 and a group of applications 415. This zero trust configuration may be based on a zero trust model for security risks. This zero trust configuration may be used to discourage transitive trust mechanisms, such as to shield a node's trustworthiness properties from direct external access. The trust brokering service 405 may implement a zero trust configuration at a network domain, such as using a domain controller, a proxy, or a broker. The zero trust configuration may be used to assess trust properties for a computing node, such as when a computing node enters the domain or during periodic reassessments. The zero trust configuration may also be used to determine whether the target device configuration can be adjusted, and adjust such configuration to reduce or minimize that the amount of filtering that a TBaaS module needs to perform. In an example, an appliance may enable a user to choose among a variety of scanning, encrypting, and signing methods, and the TBaaS can tune that target device to reduce or minimize the amount of work that falls on the TBaaS. The trust property assessments may be used to determine trustworthiness status of a node without swamping the node with attestation requests. The trustworthiness status may represent a current trustworthiness status or a trustworthiness status for a predetermined duration.

The trust brokering service 405 may also provide an attestation service. A given trust model used for an elastic workload may allow network domain boundaries to be either elastic or rigid boundaries that can be managed dynamically. However, a trust broker or other broker may not be able to represent a new domain context or different domain context for a given trust model. In an example, an attestation service may be used by a relaying party (e.g., client application, user equipment, domain controller, etc.) to offload attestation computation. The attestation service may be trusted to provide trust appraisals, but decision and enforcement may remain with the relaying party. This device attestation may be used to detect and manage changes, and to flag unexpected changes for possible attack mitigation. The attestation service may include an attestation verifier, which may identify dissimilar configurations over a period to detect unanticipated changes. Conversely, the attestation verifier may be used to identify an active trust status by detecting changes when the changes occur, such as changes that occur at boot time or at runtime. The attestation service may employ additional security monitoring capabilities besides change detection to running software, such as fuzz testing, antivirus scanning, or other security monitoring. In an example, the security monitoring includes capturing a snapshot of a workload memory image, moving that snapshot to a simulation environment, and applying an alternate form of integrity protection to the workload.

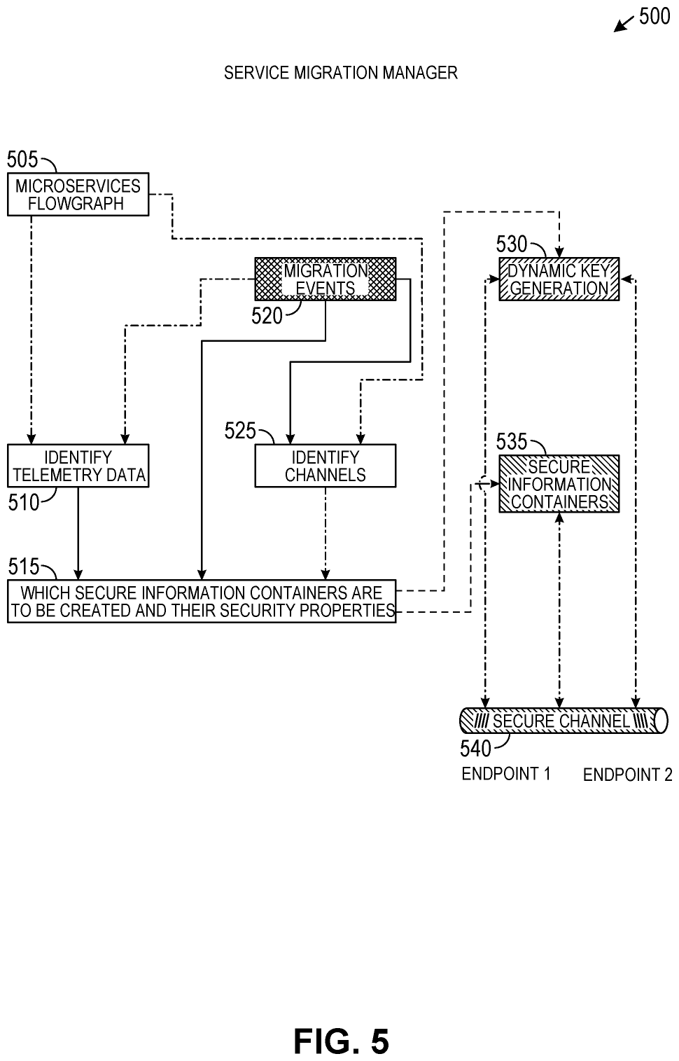

FIG. 5 is a block diagram illustrating a service migration manager architecture 500, according to an embodiment. The service migration manager architecture 500 may be used to decompose a workload into microservices, and to distribute those workload microservices across various edge computing nodes, such as across edge nodes in cloud-to-edge computing environments. This distribution may include migrating workload data sets and workload telemetry collection repositories that align with the microservices. This service migration manager architecture 500 provides improvements in protecting and routing data, results, and telemetry among microservices. The microservices may be allocated into microservice groups (e.g., pods) known as Secure Information Containers (SICs).

This migration may include routing (e.g., transferring) workload data and telemetry information dynamically among various elastic workload nodes or microservice pods. The service migration manager architecture 500 may dynamically instantiate one or more SICs, such as SIC 535. The SICs may be instantiated into Trusted Computing Base (TCB) endpoints, where TCB endpoints are source and destination nodes for workload containers. The TCB endpoints may be dynamically migrated using elastic workload node distribution and assignment to a resource hosting and management provider (e.g., infrastructure as a service (IaaS) provider).

A workload and data may be co-located to provide improved operational efficiencies and scalability, but the workload and data may be partitioned into finer grained workloads and distributed according to elastic deployment decisions. For example, an IaaS provider may identify opportunities for improved efficiencies, and may disrupt a previously optimized resourcing model. When this occurs, workload data and telemetry may no longer be optimally located relative to a workload. The service migration manager architecture 500 may provide dynamic data pooling and redistribution that optimizes data location for operational efficiency. The service migration manager architecture 500 also addresses security issues that may arise when applying elastic workload deployment decisions.

As shown in FIG. 5, microservices flowgraph 505 may represent a workload that has been decomposed into microservices. In an example, these microservices may include server-based functions and serverless functions. These microservices may be associated with security metadata, which may be provided by a workload designer. The security metadata may describe desired or required security levels, durability, and time-ordering properties of the information that moves between the different components of a workload. The security metadata may also describe or restrict where workload microservice components can migrate.

The security-annotated microservices flowgraph 505 is capable of being parsed and interpreted programmatically. The service migration manager architecture 500 may parse the microservices flowgraph 505 and identify telemetry data 510. The telemetry data 510 may be used to define point-to-point communications needs for data and telemetry, and to define security properties for transferring data and telemetry between the various microservices during execution.

The service migration manager architecture 500 may be used to identify a migration event 520. This migration event 520 may be identified by a workflow control plane (e.g., Intel® Maestro workload scheduler, Intel® Edge Multi-Cluster Orchestrator (EMCO), Kubernetes), which may determine that one or more microservices needs to be migrated from a current host or cluster to a new host or cluster. The migration event 520 may also include identifying communication channels 525 and identifying data and telemetry that will flow between services being migrated and the other services that are not being migrated. This identification may be performed initially updated incrementally for efficiency, or this identification may occur in a continually updating process.

The service migration manager architecture 500 may identify which SICs are to be created 515 and their associated security properties. This identification of which SICs are to be created 515 may be based on the migration event 520, based on the telemetry data 510, and based on the identified communication channels 525. This information may be used to generate one or more SICs 535.

The service migration manager architecture 500 may use a dynamic key generation process 530 to create temporary keys for encrypting and decrypting data to be transited through a secure channel 540. Each point-to-point workflow may be associated with a secure channel 540, and each secure channel 540 have two SICs 535 provided for each end of the workflow. In an example, workflow data may flow from a first SIC, be decrypted using a temporary encryption key from the dynamic key generation process 530, flow through the secure channel 540, be encrypted using another temporary encryption key, and be sent to a second SIC. In an example, the dynamic key generation process 530 may use a keyed hash algorithm to provide integrity protection for SIC 535 data.

Each SIC 535 may be configured to reduce or minimize encryption-decryption and physical network overheads when data is flowing within a common physical host or cluster. Each SIC 535 may also be protected by hardware protection capabilities, such as encrypted local storage, an operating system page protection mechanism, or Intel® Multi-Key Total Memory Encryption (MKTME). Each SIC 535 and each secure channel 540 may be configured to use other hardware features provided by a source host or destination host. These hardware features may include use of a programmable network adapter card (e.g., smart network interface card (SmartNIC) to accelerate applications, an Intel® Infrastructure Processing Unit (IPU) to accelerate network infrastructure, or use Intel® QuickAssist Technology (QAT) to provide cryptographic acceleration.

Each SIC 535 may function as an elastic TCB. Refactoring an edge application into microservices may use malleable (e.g., flexibly configured) TCBs to buffer information between the different refactored operations, such as workload data contained in intermediate store-and-forward messages, workload telemetry, or the results from workload execution. Malleability also extends TCB to include operational telemetry, such as telemetry that is used in making resource allocation decisions, metrics that contribute to compliance measurements, or metrics that inform security, performance, power, and resiliency assessments.

A SIC TCB may be used for secure migration of any combination of workload data sets, processing unit telemetry, or workload execution results among the different decomposed (e.g., refactored) microservices. The processing unit telemetry may include telemetry from any type of a processing unit (referred to as an “xPU”), such as a central processing unit (CPU) or graphical processing unit (GPU), and may describe processor power, performance, latency, or other processor metrics.

The service migration manager architecture 500 may determine that a workload does not need to migrate, and that the workload can be scaled between edge devices and cloud devices. In these cases, the SIC 535 may be used to facilitate workload data set synchronization based on the network topology and locality considerations.

The SIC 535 may be used to embed platform performance telemetry for various computing providers, such as using integrated device manufacturing (IDM) strategies. This embedded telemetry may use with policy-based privacy or confidentiality protection (e.g., using homomorphic encryption). The dynamic generation and management of each SIC 535 may be tracked via distributed ledger (e.g., blockchain), which may provide improved auditability and efficiency.

The SIC 535 may also provide the ability to track application quality of service (QoS) or track application service level agreement (SLA) compliance. This tracking may be used to identify, select, and manage xPUs for executing the microservices. In an example, if a cloud computing environment offers a GPU with enhanced AI capabilities but an edge device does not include a GPU, the system may revert to using a CPU at the edge device if the desired QoS can be maintained within a QoS tolerance profile.

The SIC TCB provides the ability for streaming data sources and data sinks independent of where data cached, buffered, replicated, or physically resides. The SIC TCB infrastructure may be provisioned dynamically, which may provide functionality typically associated with a storage area network (SAN) or other data repository infrastructure. In an example, this dynamic provisioning may include expanding data storage without needing the workload to be aware of or statically reconfigure respective network locations. An elastic workload management may be implemented in a Container as a Service (CaaS) infrastructure, which may be used to improve or optimize data placement to achieve desired workload performance, scalability, availability, and resiliency benefits.

The SIC TCB may be used to buffer information between various workload pods. Workload pods may initially be co-located in an all-to-all communication cluster within a common static TCB to achieve operational efficiencies and scalability, and may subsequently be migrated such that they are no longer co-located. The information buffering may be particularly useful for workload pods that share data or operations across heterogeneous security boundaries. In such situations, each SIC 535 may be generated by allocating trusted island TCBs that apply integrity and confidentiality protections when transferring workload data.

A workload manager may be used to optimize the creation of secure channels 540. This optimization may be used to reduce or minimize the number of secure channels 540 before or during workflow migration events 520. In an example, a Container as a Service (CaaS) workload manager (e.g., Intel® Maestro-A) may be used to reduce or minimize the number of secure channels 540, and an Infrastructure as a Service (IaaS) workload manager (e.g., Intel® Maestro-I) may be used during workflow migration events 520. The CaaS workload manager may be used in the formation of channels such as secure channel 540, including configuring channel properties such as security, durability, or ordered delivery. The CaaS workload manager may be used to determine a microservices flowgraph 505 based on workflow metadata and available factored workflow components.

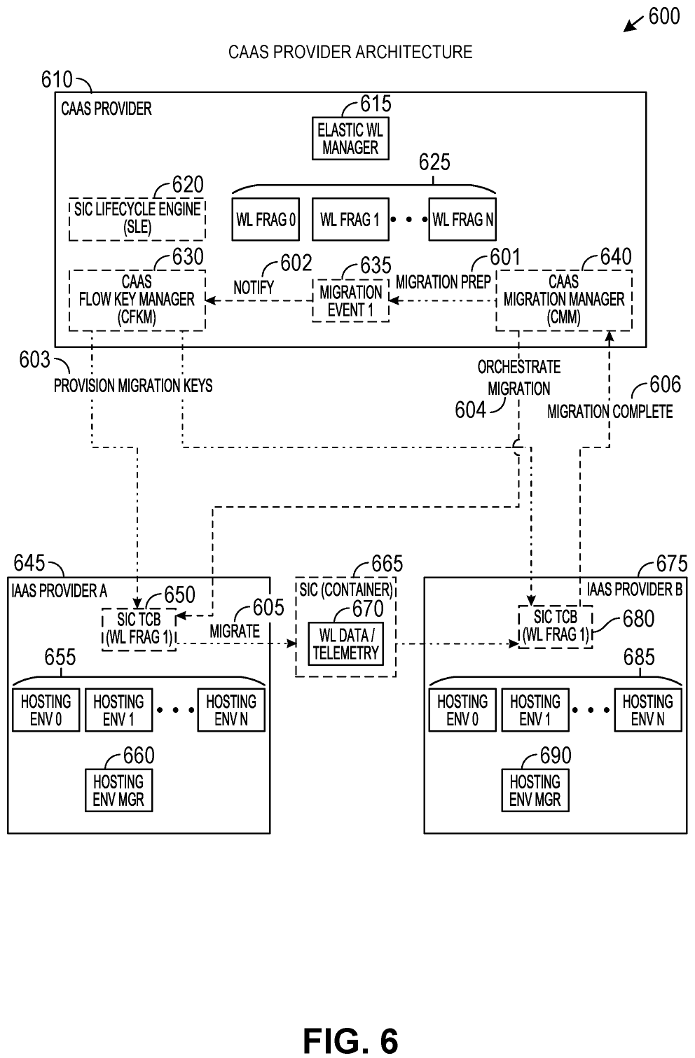

The IaaS workload manager may be used to improve or maximize the communication performance of the secure channels 540, such as by preferring or requiring communication directly between data producers and data consumers co-located on a common host or within a common virtual execution environment (e.g., VM, virtual container) whenever possible. Direct communication may not always be possible, such as when buffering, queuing, QoS, or other constraints preclude direct streaming. When direct communication is not possible, an SIC 535 may function as a data intermediary that transparently implements buffering with the required security properties. The CaaS and IaaS workload managers are described further with respect to FIG. 6.

FIG. 6 is a block diagram illustrating a CaaS provider architecture 600, according to an embodiment. The CaaS provider architecture 600 shows architecture components and an example workload migration sequence for managing SICs. A CaaS provider 610 may include an elastic workload manager 615 and several workload fragments 625. The CaaS provider 610 may further include a CaaS Migration Manager (CMM 640), a CaaS Flow Key Manager (CFKM 630), and a SIC Lifecycle Engine (SLE 620). The CMM 640 and the CFKM 630 may interact with one or more IaaS providers, such as source IaaS provider A 645 and destination IaaS provider B 675. The IaaS providers may provide hosting support for containers, such as bare metal host containers, virtual machine hosted containers, Intel® Software Guard Extension (Intel® SGX) enclaves that host containers, Intel® Trust Domain Extension (Intel® TDX) domains that host containers, and other container hosts.

Each IaaS hosting environment may include a SIC TCB, such as first SIC TCB 650 at source IaaS provider A 645 and second SIC TCB 680 at destination IaaS provider B 675. The source IaaS provider A 645 may include several hosting environments 655 and a hosting environment manager 660. Similarly, the IaaS provider B 675 may include several hosting environments 685 and a hosting environment manager 690. These SIC TCBs may be part of a container's library OS (LibOS), or may be built into a container's native hosting environment as system software or firmware. Each data container may be used to protect workload data and telemetry that is migrated, such as from a source IaaS provider A 645 to destination IaaS provider B 675.

The SLE 620 may be used to manage a SIC container lifecycle based on provisioned policies. This may include determining when it is appropriate for a container migration flow to be initiated. The CMM 640 may implement a migration flow state machine, which may be used to verify that a migration has completed as expected, or to roll back to a pre-migration state if the migration does not complete as expected. In an example, distributed block chain transaction tracking may be used to track the activities of the SLE 620 or the CMM 640, such as when the SLE 620 and the CMM 640 are implemented across one or more CaaS providers or between the edge and cloud.

The CFKM 630 may be used to manage secure keys. The CFKM 630 may use a dynamic key-minting process to create temporary keys necessary for encrypting and decrypting data to be transited. Each point-to-point data flow may be associated with respective secure channel, where each channel may have a pair of SICs, each associated with one end of the secure channel. This configuration enables data to flow seamlessly between each endpoint and its SIC. Once at the SIC, the data may be encrypted or decrypted as needed before being sent to a SIC at the other end of the secure channel.

As shown in FIG. 6, an example workload migration sequence may begin with migration preparation 601. The migration preparation 601 may include the CMM 640 triggering a SIC container migration event, which may create a migration event structure 635. This SIC container migration event may be triggered based on control plane workload scalability needs from edge to cloud. The migration event structure 635 may describe the workload, workload data, source IaaS provider, telemetry related to the source IaaS provider, destination IaaS provider, telemetry related to the destination IaaS provider, container protection method (e.g., encryption using symmetric keys), key exchange or key agreement protocol, migration time window, and other migration event data.

In response to the creation of the migration event structure 635, a notification event 602 may be delivered to the CFKM 630. In response to receipt of the notification event 602, the CFKM 630 may perform key management operations related to SIC container migration. Based on the receipt or content of the notification event 602, the CFKM 630 may perform dynamic key-minting to create temporary keys necessary for securing the telemetry and workload data to be transmitted securely for the current migration.

The CFKM 630 may provision migration keys 603 to source IaaS provider A 645 and to destination IaaS provider B 675. The CFKM 630 may use one or more key management solutions to provision migration keys securely, such as Kerberos, Public key infrastructure (PKI), signed Diffie-Hellman, password-authenticated key exchange (PAKE), or other key management solutions.

In response to successful completion of migration key provisioning, the CFKM 630 may generate a key success indication. In an example, the key success indication may take the form of an acknowledgement indication sent in response to the notification event 602. In another example, an acknowledgement may be generated in response to notification event 602, and a subsequent completion notification may be sent separately. If an error occurred in provisioning of migration keys, that a negative completion message may also be sent in response to identification of that error. In response to a successful key provisioning, the CMM 640 may orchestrate the migration 604, which may include signaling a SIC TCB 650 of source IaaS provider A 645 to prepare the SIC container and apply the specified container protection (e.g., encryption).

The source IaaS provider A 645 and the first SIC TCB 650 may be used for migration 605 of the SIC container 665 and any associated workload data or telemetry 670. The SIC container 665 may be migrated from the first SIC TCB 650 to the second SIC TCB 680 within the IaaS provider B 675. To perform this migration 605, the source IaaS provider A 645 may obtain privileged access to the IaaS provider B 675, such as using an OAuth2 token, Open ID Connect (OIDC) token, a certificate, a challenge-response interaction, API Key, or other form of access authorization. Upon completion of the SIC container migration 605, the second SIC TCB 680 may send a notification to the CMM 640 to indicate the migration is complete 606.

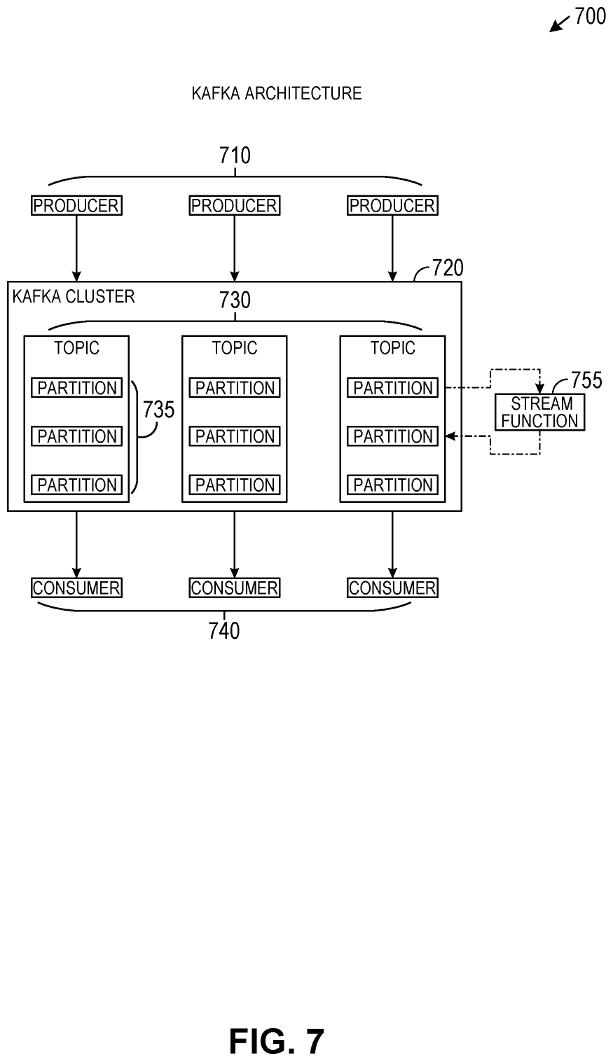

FIG. 7 is a block diagram illustrating a Kafka architecture 700, according to an embodiment. The workflow migration sequence and architecture components may be implemented using Kafka architecture 700. The Kafka architecture 700 may include a publish-subscribe messaging system that accepts messages from a set of message producers 710, and re-publishes those messages through a Kafka cluster 720 to a set of message consumers 740.

The Kafka architecture 700 may be viewed as an IaaS for messaging. These messages may be organized into topics 730 with individual partitions 735, which may include message grouping metadata. A stream function 755 may be applied to messages from a source or ingress partition and written into a destination or egress partition to form a pipeline of functions. This function pipelining may be used within a Kafka cluster 720 to provide a cluster of microservices or FaaS. Multiple clusters may be connected to allow offloading of functions for continuing a pipeline, or to rebalance a computing load of one cluster to another cluster. The ingress-egress flow may be redirected to a second Kafka cluster or to a local redundancy cluster, where the stream function and related data can be securely migrated using a SIC container and SIC TCB.

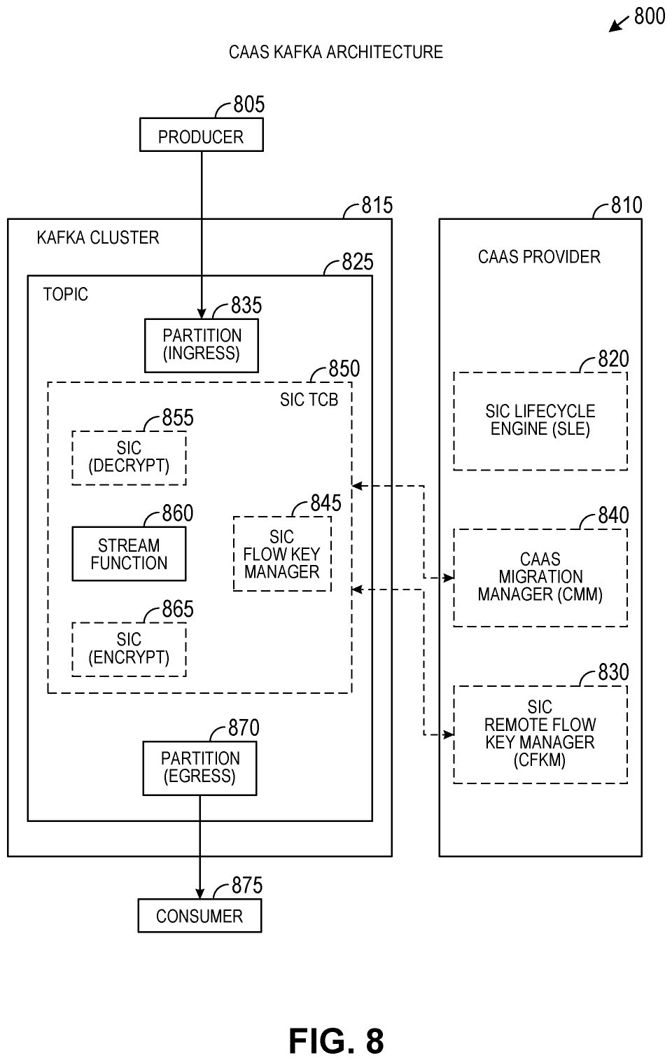

FIG. 8 is a block diagram illustrating a CaaS provider architecture 800, according to an embodiment. The CaaS provider architecture 800 shows an example integration of a CaaS provider 810 with a Kafka cluster 815, such as CaaS provider architecture 600 integrated with Kafka architecture 700.

In the example shown in FIG. 8, the CaaS provider 810 may include a SIC Lifecycle Engine (SLE 820), a CaaS Migration Manager (CMM 840), and a CaaS Flow Key Manager (CFKM 830). These components may be configured to provide functionality analogous to the functionality of the SLE 620, the CMM 640, and the CFKM 630. In another example, the SLE 820, CMM 840, and CFKM 830 may be hosted within a Kafka cluster environment.

The CaaS provider 810 may interact with a topic 825 within the Kafka cluster 815, such as through a SIC TCB 850. The SIC TCB 850 may include a SIC flow manager 845, decryption SIC 855, and encryption SIC 865, such as to provide encryption and decryption during workflow migration. The Kafka cluster 815 may be regarded as an IaaS that specializes in message-oriented workflow. As with the Kafka architecture 700, the Kafka cluster 815 may receive messages from a producer 805 at an ingress partition 835, apply a stream function 860 the received messages, and write messages through an egress partition 870 to a consumer 875.

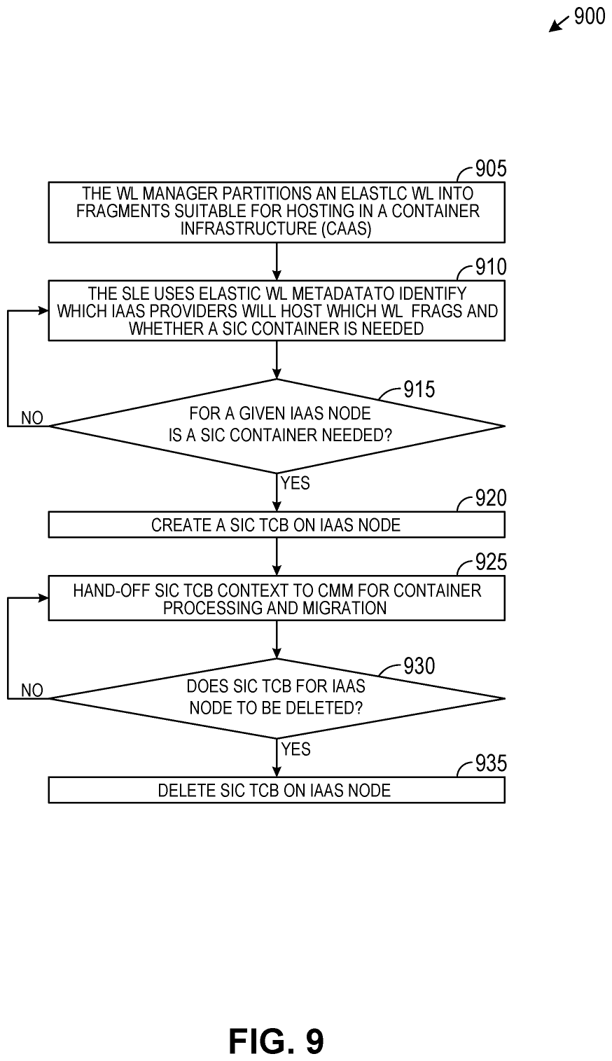

FIG. 9 is a flow diagram illustrating elastic workload partitioning and SIC lifecycle management method 900, according to an embodiment. Method 900 shows the operational flow sequence of workload migration using a SIC-TCB workload dataset and telemetry. This operational flow sequence focuses on setup and tear-down operations for the workload dataset and telemetry within an elastic edge to cloud environment.

Method 900 includes a workload manager partitioning 905 a workload into fragments suitable for deployment in a container infrastructure, such as a CaaS. The CaaS may include a CaaS layer, and this CaaS layer may employ an IaaS infrastructure layer that contains infrastructure for supporting execution, storage, and communications functionality.

Method 900 further includes an SLE identification 910 of IaaS resource requirements. The SLE may use elastic workload metadata to determine the IaaS resource requirements needed to host the various workloads that have been fragmented from the main elastic workload. The SLE may also determine whether a SIC container is needed to perform a container migration.

Method 900 further includes determining whether a SIC container is required 915 for a given IaaS node. If a SIC container is not required, method 900 may return to the SLE identification 910. If SIC container is required, method 900 proceeds to create 920 a SIC TCB on the source IaaS node.

Method 900 further includes handing off SIC TCB context 925 to a CMM for container processing and migration. This SIC TCB context 925 may include data that is to be used for the container migration. The SIC TCB context 925 may be held in reserve while a CMM processes and orchestrates a container migration. Once the migration completes, method 900 may determine whether the SIC TCB context needs to be deleted 930. If the context is not to be deleted, method 900 returns to SIC TCB context 925. If the context is to be deleted, the SIC TCB resources and presence is deleted 935 from the LaaS node.

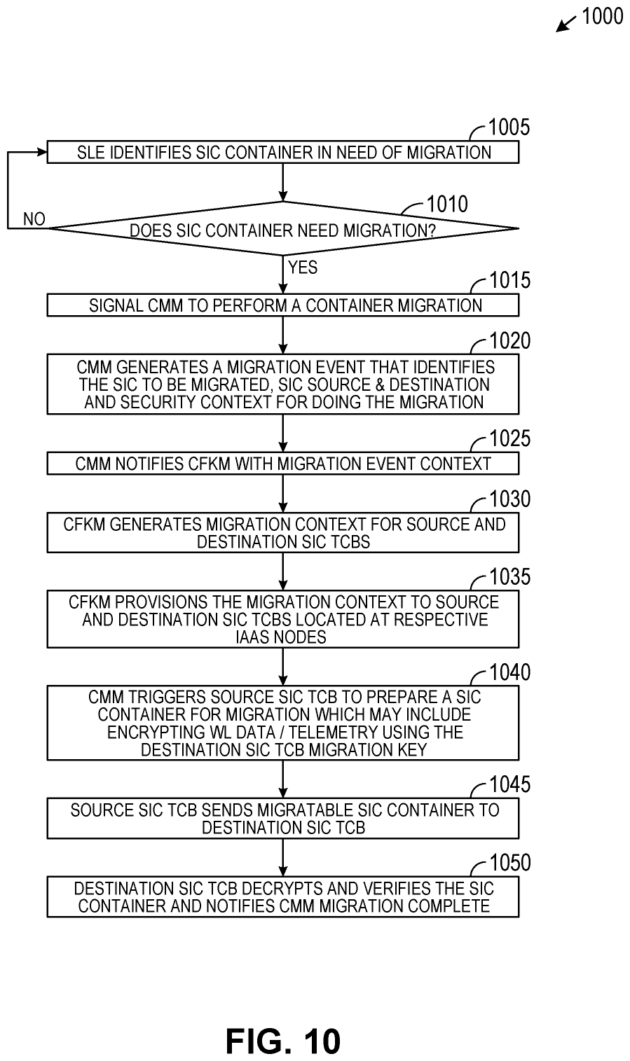

FIG. 10 is a block diagram illustrating a secure container migration flow method 1000, according to an embodiment. Method 1000 begins with an SLE identifying a SIC container that is to be migrated 1005. This identification may be based on a request received from a CaaS orchestrator. In an example, the request may be directed from an orchestration console, user console, or administrator console. In another example, an IaaS resource manager may detect resource utilization conditions that require resource balancing, redundancy, or sharing that motivates container migration. If method 1000 determines that the SIC container needs migration 1010, then method 1000 proceeds with the SLE signaling the CMM 1015 to perform the container migration between a source IaaS provider and a source container to a destination IaaS provider.

Method 1000 includes a CMM generating a migration event 1020. The migration event may identify the SIC container, source and destination nodes, the data to be migrated, and any SIC TCBs used and the security context. The CMM then notifies the CFKM 1025 with a migration event context. Using this notification, the CFKM generates the migration context 1030 for both source and destination SIC TCBs. The CFKM may then provision the migration context 1035 into both the source and destination SIC TCBs on the respective IaaS nodes.

Method 1000 includes the CMM triggering the migration to be performed 1040. This may include notifying the CFKM which in turn notifies the SIC TCBs, or may include the CMM directly notifying the SIC TCBs. Upon receipt of the notifications, the SIC TCBs may generate and use cryptographic keys using the provisioned security contexts. The source SIC TCB may then encrypt the SIC container with the workload contents.

Method 1000 includes the source SIC TCB sending the SIC container 1045 to the destination SIC TCB. The destination SIC TCB may then complete the migration 1050 by decrypting and verifying container contents, preparing container contents for use by the IaaS node, and notifying the CMM that the migration is complete. The CMM may in turn notify the SLE the migration is complete. Subsequently, the destination IaaS node may resume container processing on the destination IaaS node, and the SIC TCB may be deleted from the IaaS node.

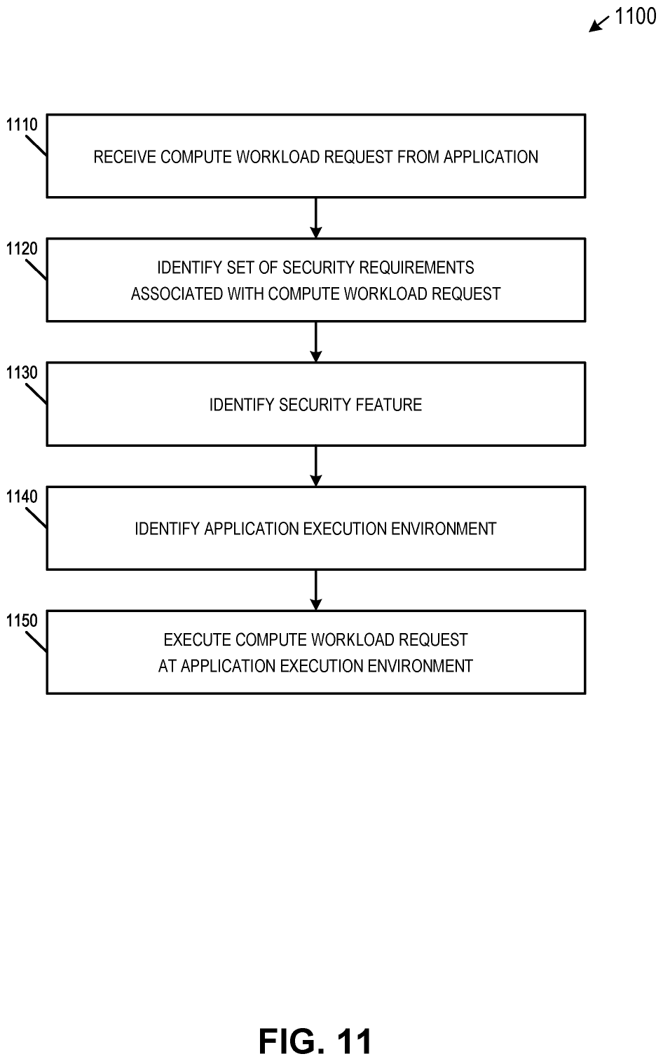

FIG. 11 is a flow diagram illustrating a method 1100 for trust brokering as a service, according to an embodiment. Method 1100 includes receiving 1110 a computing workload request at a trust brokering service edge computing device from an application configured to process secure data. Method 1100 includes identifying 1120 a set of security requirements associated with the computing workload request and identifying 1130 a security feature present in the set of security requirements but not provided by an edge computing node.

Using this identified security feature, method 1100 includes identifying an application execution environment 1140. The application execution environment may include a secure plugin providing the security feature and a virtual device representing the edge computing node. Method 1100 may include executing the computing workload request 1150 at the application execution environment.

The execution environment may include at least one of an application sidecar, a logical network slice, or a scalable input/output virtualization (IOV). The logical network slice may include a dynamically created logical network subset, and the logical network slice may be associated with a set of logical network function instances and a set of logical network resources. The scalable IOV may include a set of dynamically reallocated logical network resources, which may include at least one of logical compute resources, logical storage resources, and logical network communication resources.

The execution environment may be implemented within a virtual machine, where the virtual machine may emulate a physical compute device within a host machine. The execution environment may be implemented within a virtual container, where the virtual container may include a virtual application and a set of application dependencies.

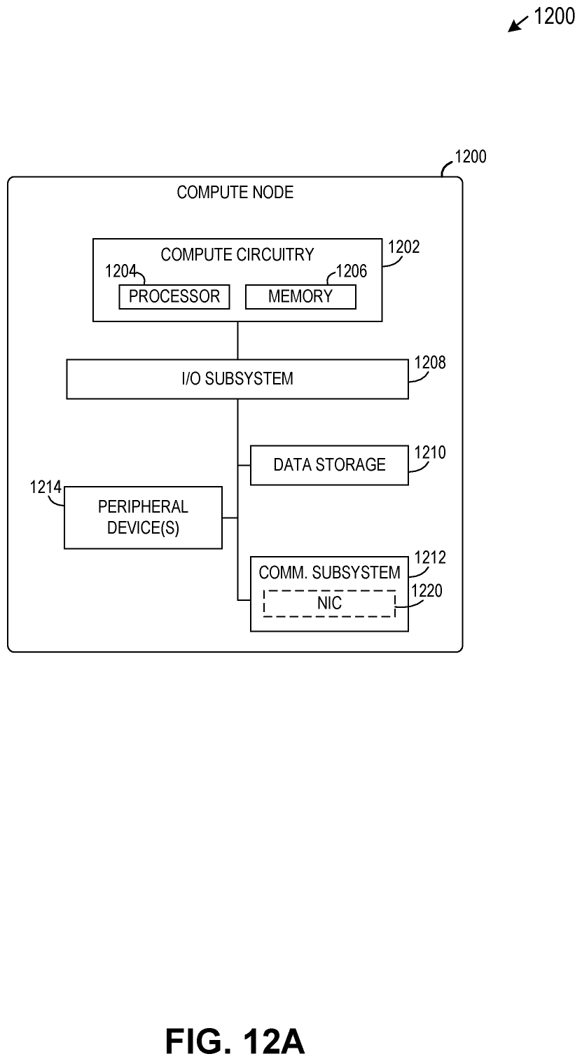

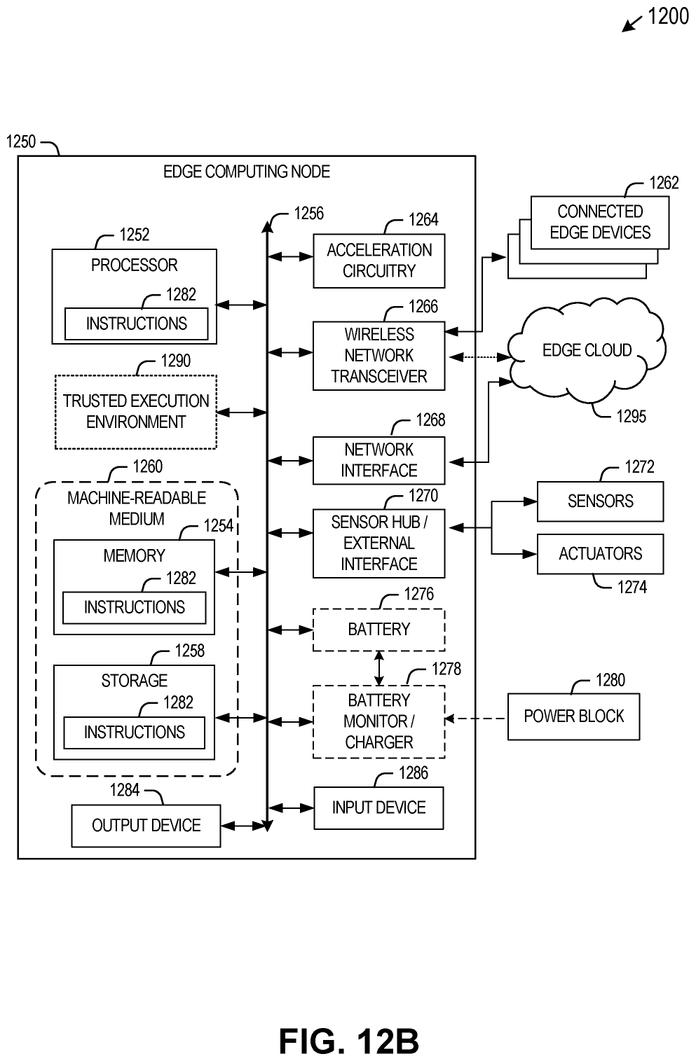

FIGS. 12A and 12B provide an overview of example components within a computing device in an edge computing system 1200, according to an embodiment. Edge computing system 1200 may be used to provide secure and attestable functions-as-a-service, such as using method 1100 and related systems and methods described above with respect to FIG. 1 through FIG. 11.

In further examples, any of the compute nodes or devices discussed with reference to the present edge computing systems and environment may be fulfilled based on the components depicted in FIGS. 12A and 12B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 12A, an edge compute node 1200 includes a compute engine (also referred to herein as “compute circuitry”) 1202, an input/output (I/O) subsystem 1208 (also referred to herein as “I/O circuitry”), data storage 1210 (also referred to herein as “data storage circuitry”), a communication circuitry subsystem 1212, and, optionally, one or more peripheral devices 1214 (also referred to herein as “peripheral device circuitry”). In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1200 may be embodied as any type of engine, device, or collection of devices capable of performing various compute functions. In some examples, the compute node 1200 may be embodied as a single device such as an integrated circuit, an embedded system, a field-programmable gate array (FPGA), a system-on-a-chip (SOC), or other integrated system or device. In the illustrative example, the compute node 1200 includes or is embodied as a processor 1204 (also referred to herein as “processor circuitry”) and a memory 1206 (also referred to herein as “memory circuitry”). The processor 1204 may be embodied as any type of processor capable of performing the functions described herein (e.g., executing an application). For example, the processor 1204 may be embodied as a multi-core processor(s), a microcontroller, a processing unit, a specialized or special purpose processing unit, or other processor or processing/controlling circuit.

In some examples, the processor 1204 may be embodied as, include, or be coupled to an FPGA, an application specific integrated circuit (ASIC), reconfigurable hardware or hardware circuitry, or other specialized hardware to facilitate performance of the functions described herein. In some examples, the processor 1204 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that a xPU, a SOC, a CPU, and other variations of the processor 1204 may work in coordination with each other to execute many types of operations and instructions within and on behalf of the compute node 1200.

The memory 1206 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three dimensional crosspoint memory device, or other byte addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a combination of any of the above, or other suitable memory. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the memory 1206 may be integrated into the processor 1204. The memory 1206 may store various software and data used during operation such as one or more applications, data operated on by the application(s), libraries, and drivers.

In some examples, resistor-based and/or transistor-less memory architectures include nanometer scale phase-change memory (PCM) devices in which a volume of phase-change material resides between at least two electrodes. Portions of the example phase-change material exhibit varying degrees of crystalline phases and amorphous phases, in which varying degrees of resistance between the at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods of time (e.g., approximately 10 years at room temperature). Write operations to example PCM devices (e.g., set to logical “0,” set to logical “1,” set to an intermediary resistance value) are accomplished by applying one or more current pulses to the at least two electrodes, in which the pulses have a particular current magnitude and duration. For instance, a long low current pulse (SET) applied to the at least two electrodes may cause the example PCM device to reside in a low-resistance crystalline state, while a comparatively short high current pulse (RESET) applied to the at least two electrodes causes the example PCM device to reside in a high-resistance amorphous state.

In some examples, implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann computing architectures. However, PCM devices minimize and, in some cases, eliminate data transfers between the CPU and memory by performing some computing operations in-memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 1202 is communicatively coupled to other components of the compute node 1200 via the I/O subsystem 1208, which may be embodied as circuitry and/or components to facilitate input/output operations with the compute circuitry 1202 (e.g., with the processor 1204 and/or the main memory 1206) and other components of the compute circuitry 1202. For example, the I/O subsystem 1208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1208 may form a portion of a system-on-a-chip (SoC) and be incorporated, along with one or more of the processor 1204, the memory 1206, and other components of the compute circuitry 1202, into the compute circuitry 1202.

The one or more illustrative data storage devices/disks 1210 may be embodied as one or more of any type(s) of physical device(s) configured for short-term or long-term storage of data such as, for example, memory devices, memory, circuitry, memory cards, flash memory, hard disk drives, solid-state drives (SSDs), and/or other data storage devices/disks. Individual data storage devices/disks 1210 may include a system partition that stores data and firmware code for the data storage device/disk 1210. Individual data storage devices/disks 1210 may also include one or more operating system partitions that store data files and executables for operating systems depending on, for example, the type of compute node 1200.

The communication circuitry 1212 may be embodied as any communication circuit, device, or collection thereof, capable of enabling communications over a network between the compute circuitry 1202 and another compute device (e.g., an edge gateway of an implementing edge computing system). The communication circuitry 1212 may be configured to use any one or more communication technology (e.g., wired communications, wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1212 includes a network interface controller (NIC) 1220, which may also be referred to as a host fabric interface (HFI). The NIC 1220 may be embodied as one or more add-in-boards, daughter cards, network interface cards, controller chips, chipsets, or other devices that may be used by the compute node 1200 to connect with another compute device (e.g., an edge gateway node). In some examples, the NIC 1220 may be embodied as part of a system-on-a-chip (SoC) that includes one or more processors, or included on a multichip package that also contains one or more processors. In some examples, the NIC 1220 may include a local processor (not shown) and/or a local memory (not shown) that are both local to the NIC 1220. In such examples, the local processor of the NIC 1220 may be capable of performing one or more of the functions of the compute circuitry 1202 described herein. Additionally, or alternatively, in such examples, the local memory of the NIC 1220 may be integrated into one or more components of the client compute node at the board level, socket level, chip level, and/or other levels.

Additionally, in some examples, a respective compute node 1200 may include one or more peripheral devices 1214. Such peripheral devices 1214 may include any type of peripheral device found in a compute device or server such as audio input devices, a display, other input/output devices, interface devices, and/or other peripheral devices, depending on the particular type of the compute node 1200. In further examples, the compute node 1200 may be embodied by a respective edge compute node (whether a client, gateway, or aggregation node) in an edge computing system or like forms of appliances, computers, subsystems, circuitry, or other components.

In a more detailed example, FIG. 12B illustrates a block diagram of an example of components that may be present in an edge computing node 1250 for implementing the techniques (e.g., operations, processes, methods, and methodologies) described herein. This edge computing node 1250 provides a closer view of the respective components of node 1200 when implemented as or as part of a computing device (e.g., as a mobile device, a base station, server, gateway, etc.). The edge computing node 1250 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1250, or as components otherwise incorporated within a chassis of a larger system.

The edge computing device 1250 may include processing circuitry in the form of a processor 1252, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1252 may be a part of a system on a chip (SoC) in which the processor 1252 and other components are formed into a single integrated circuit, or a single package, such as the Edison™ or Galileo™ SoC boards from Intel Corporation, Santa Clara, California. As an example, the processor 1252 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1252 and accompanying circuitry may be provided in a single socket form factor, multiple socket form factor, or a variety of other formats, including in limited hardware configurations or configurations that include fewer than all elements shown in FIG. 12B.

The processor 1252 may communicate with a system memory 1254 over an interconnect 1256 (e.g., a bus). Any number of memory devices may be used to provide for a given amount of system memory. As examples, the memory 1254 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1258 may also couple to the processor 1252 via the interconnect 1256. In an example, the storage 1258 may be implemented via a solid-state disk drive (SSDD). Other devices that may be used for the storage 1258 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory.

In low power implementations, the storage 1258 may be on-die memory or registers associated with the processor 1252. However, in some examples, the storage 1258 may be implemented using a micro hard disk drive (HDD). Further, any number of recent technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1256 may couple the processor 1252 to a transceiver 1266, for communications with the connected edge devices 1262. The transceiver 1266 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1262. For example, a wireless local area network (WLAN) unit may be used to implement Wi-Fi® communications in accordance with the IEEE 802.11 standard. In addition, wireless wide area communications, e.g., according to a cellular or other wireless wide area protocol, may occur via a wireless wide area network (WWAN) unit.

The wireless network transceiver 1266 (or multiple transceivers) may communicate using multiple standards or radios for communications at a different range. For example, the edge computing node 1250 may communicate with close devices, e.g., within about 10 meters, using a local transceiver based on Bluetooth Low Energy (BLE), or another low power radio, to save power. More distant connected edge devices 1262, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1266 (e.g., a radio transceiver) may be included to communicate with devices or services in a cloud (e.g., an edge cloud 1295) via local or wide area network protocols. The wireless network transceiver 1266 may be a low-power wide-area (LPWA) transceiver that follows the IEEE 802.15.4, or IEEE 802.15.4g standards, among others. The edge computing node 1250 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1266, as described herein. For example, the transceiver 1266 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1266 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (MC) 1268 may be included to provide a wired communication to nodes of the edge cloud 1295 or to other devices, such as the connected edge devices 1262 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to enable connecting to a second network, for example, a first NIC 1268 providing communications to the cloud over Ethernet, and a second NIC 1268 providing communications to other devices over another type of network.

Given the variety of types of applicable communications from the device to another component or network, applicable communications circuitry used by the device may include or be embodied by any one or more of components 1264, 1266, 1268, or 1270. Accordingly, in various examples, applicable means for communicating (e.g., receiving, transmitting, etc.) may be embodied by such communications circuitry.

The edge computing node 1250 may include or be coupled to acceleration circuitry 1264, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1256 may couple the processor 1252 to a sensor hub or external interface 1270 that is used to connect additional devices or subsystems. The devices may include sensors 1272, such as accelerometers, level sensors, flow sensors, optical light sensors, camera sensors, temperature sensors, global navigation system (e.g., GPS) sensors, pressure sensors, barometric pressure sensors, and the like. The hub or interface 1270 further may be used to connect the edge computing node 1250 to actuators 1274, such as power switches, valve actuators, an audible sound generator, a visual warning device, and the like.

In some optional examples, various input/output (I/O) devices may be present within or connected to, the edge computing node 1250. For example, a display or other output device 1284 may be included to show information, such as sensor readings or actuator position. An input device 1286, such as a touch screen or keypad may be included to accept input. An output device 1284 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1250. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1276 may power the edge computing node 1250, although, in examples in which the edge computing node 1250 is mounted in a fixed location, it may have a power supply coupled to an electrical grid, or the battery may be used as a backup or for temporary capabilities. The battery 1276 may be a lithium ion battery, or a metal-air battery, such as a zinc-air battery, an aluminum-air battery, a lithium-air battery, and the like.

A battery monitor/charger 1278 may be included in the edge computing node 1250 to track the state of charge (SoCh) of the battery 1276, if included. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1278 may communicate the information on the battery 1276 to the processor 1252 over the interconnect 1256. The battery monitor/charger 1278 may also include an analog-to-digital (ADC) converter that enables the processor 1252 to directly monitor the voltage of the battery 1276 or the current flow from the battery 1276. The battery parameters may be used to determine actions that the edge computing node 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the edge computing node 1250. A wireless battery charging circuit, such as an LTC4020 chip from Linear Technologies of Milpitas, California, among others, may be included in the battery monitor/charger 1278. The specific charging circuits may be selected based on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the processor 1252 may be embodied as a non-transitory, machine-readable medium 1260 including code to direct the processor 1252 to perform electronic operations in the edge computing node 1250. The processor 1252 may access the non-transitory, machine-readable medium 1260 over the interconnect 1256. For instance, the non-transitory, machine-readable medium 1260 may be embodied by devices described for the storage 1258 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 1260 may include instructions to direct the processor 1252 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 1282 on the processor 1252 (separately, or in combination with the instructions 1282 of the machine readable medium 1260) may configure execution or operation of a trusted execution environment (TEE) 1290. In an example, the TEE 1290 operates as a protected area accessible to the processor 1252 for secure execution of instructions and secure access to data. Various implementations of the TEE 1290, and an accompanying secure area in the processor 1252 or the memory 1254 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1250 through the TEE 1290 and the processor 1252.

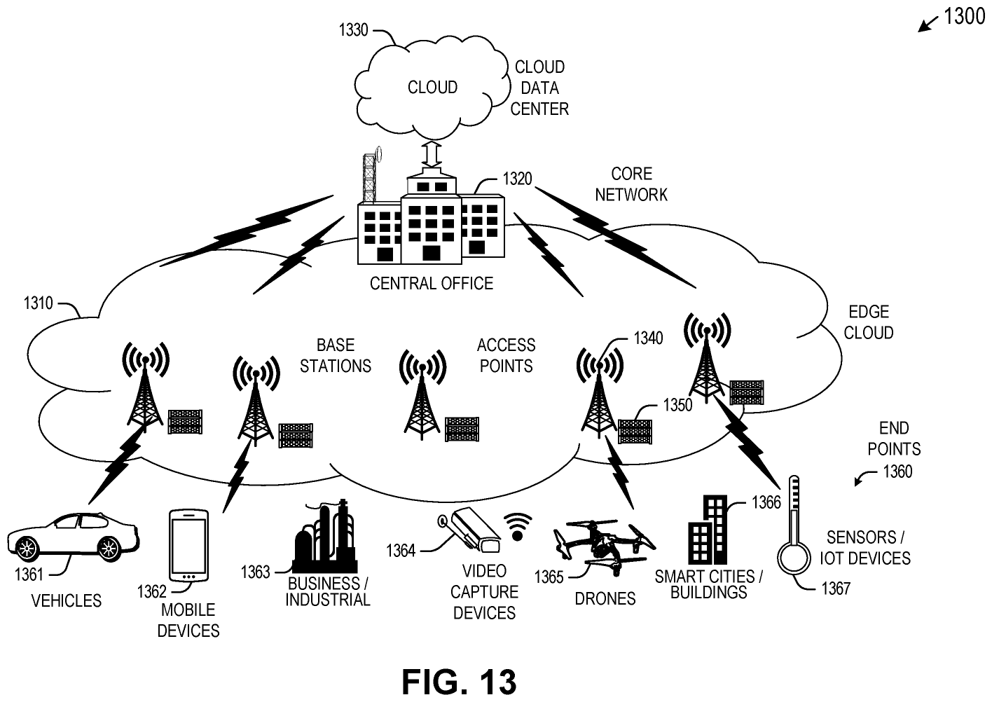

FIG. 13 is a block diagram showing an overview of a configuration for edge computing, which includes a layer of processing referred to in many of the following examples as an “edge cloud.” As shown, the edge cloud 1310 is co-located at an edge location, such as an access point or base station 1340, a local processing hub 1350, or a central office 1320, and thus may include multiple entities, devices, and equipment instances. The edge cloud 1310 is located much closer to the endpoint (consumer and producer) data sources 1360 (e.g., autonomous vehicles 1361, user equipment 1362, business and industrial equipment 1363, video capture devices 1364, drones 1365, smart cities and building devices 1366, sensors and IoT devices 1367, etc.) than the cloud data center 1330. Compute, memory, and storage resources which are offered at the edges in the edge cloud 1310 are critical to providing ultra-low latency response times for services and functions used by the endpoint data sources 1360 as well as reduce network backhaul traffic from the edge cloud 1310 toward cloud data center 1330 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce an amount or number of resources needed for network services, through the distribution of more resources which are located closer both geographically and in network access time. In this manner, edge computing attempts to bring the compute resources to the workload data where appropriate or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

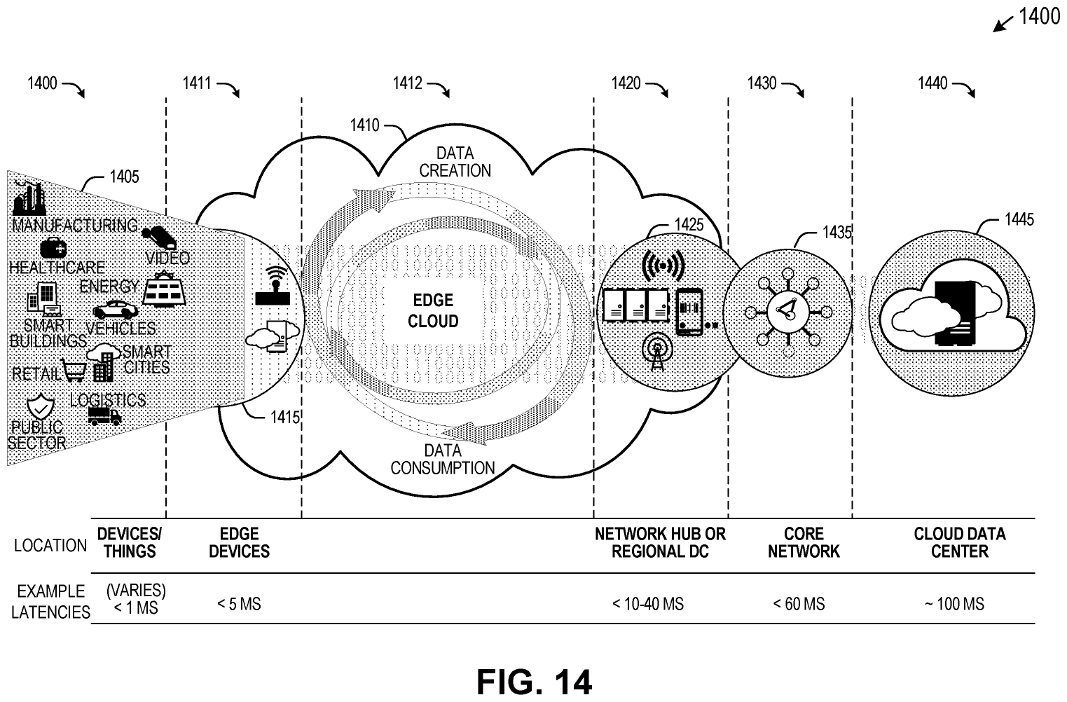

FIG. 14 illustrates operational layers among endpoints, an edge cloud, and cloud computing environments 1400, according to an embodiment. Specifically, FIG. 14 depicts examples of computational use cases 1405, using the edge cloud 1410 among multiple illustrative layers of network computing, such as using edge cloud 1310 shown in FIG. 13. The layers begin at an endpoint (devices and things) layer 1400, which accesses the edge cloud 1410 to conduct data creation, analysis, and data consumption activities. The edge cloud 1410 may span multiple network layers, such as an edge devices layer 1411 having gateways, on-premise servers, or network equipment (nodes 1415) located in physically proximate edge systems; a network access layer 1420, encompassing base stations, radio processing units, network hubs, regional data centers (DC), or local network equipment (equipment 1425); and any equipment, devices, or nodes located therebetween (in layer 1412, not illustrated in detail). The network communications within the edge cloud 1410 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1400, under 5 ms at the edge devices layer 1410, to even between 10 to 40 ms when communicating with nodes at the network access layer 1420. Beyond the edge cloud 1410 are core network 1430 and cloud data center 1440 layers, each with increasing latency (e.g., between 50-60 ms at the core network layer 1430, to 100 or more ms at the cloud data center layer). As a result, operations at a core network data center 1435 or a cloud data center 1445, with latencies of at least 50 to 100 ms or more, will not be able to accomplish many time-critical functions of the use cases 1405. Each of these latency values are provided for purposes of illustration and contrast; it will be understood that the use of other access network mediums and technologies may further reduce the latencies. In some examples, respective portions of the network may be categorized as “close edge,” “local edge,” “near edge,” “middle edge,” or “far edge” layers, relative to a network source and destination. For instance, from the perspective of the core network data center 1435 or a cloud data center 1445, a central office or content data network may be considered as being located within a “near edge” layer (“near” to the cloud, having high latency values when communicating with the devices and endpoints of the use cases 1405), whereas an access point, base station, on-premise server, or network gateway may be considered as located within a “far edge” layer (“far” from the cloud, having low latency values when communicating with the devices and endpoints of the use cases 1405). It will be understood that other categorizations of a particular network layer as constituting a “close,” “local,” “near,” “middle,” or “far” edge may be based on latency, distance, number of network hops, or other measurable characteristics, as measured from a source in any of the network layers 1400 through 1440.

The various use cases 1405 may access resources under usage pressure from incoming streams, due to multiple services utilizing the edge cloud. To achieve results with low latency, the services executed within the edge cloud 1410 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement remediation measures.

Thus, with these variations and service features in mind, edge computing within the edge cloud 1410 may provide the ability to serve and respond to multiple applications of the use cases 1405 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 1410 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1410 (network layers 1400 through 1440), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco,” or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1410.

As such, the edge cloud 1410 is formed from network components and functional features operated by and within edge gateway nodes, edge aggregation nodes, or other edge compute nodes among network layers 1410 through 1430. The edge cloud 1410 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1410 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be used in place of or in combination with such 3GPP carrier networks.

The network components of the edge cloud 1410 may be servers, multi-tenant servers, appliance computing devices, and/or any other type of computing devices. For example, the edge cloud 1410 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, edge devices are devices presented in the network for a specific purpose (e.g., a traffic light), but may have processing and/or other capacities that may be used for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 12B. The edge cloud 1410 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

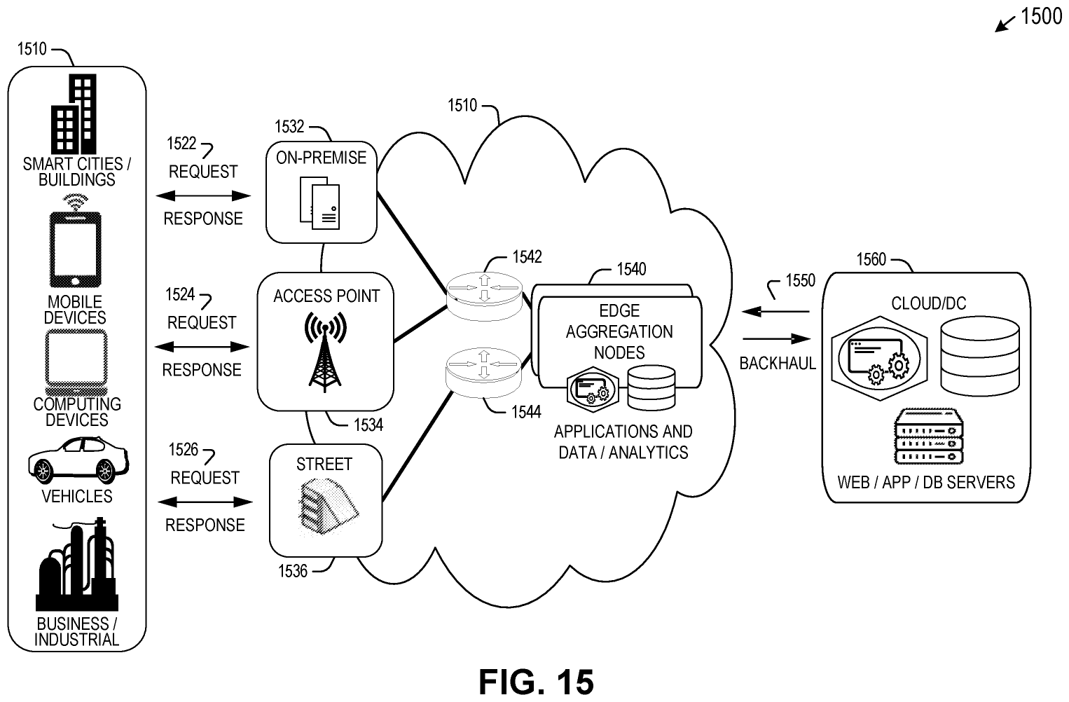

FIG. 15 illustrates an example approach for networking and services in an edge computing system, according to an embodiment. In FIG. 15, various client endpoints 1510 (in the form of mobile devices, computers, autonomous vehicles, business computing equipment, industrial processing equipment) exchange requests and responses that are specific to the type of endpoint network aggregation. For instance, client endpoints 1510 may obtain network access via a wired broadband network, by exchanging requests and responses 1522 through an on-premises network system 1532. Some client endpoints 1510, such as mobile computing devices, may obtain network access via a wireless broadband network, by exchanging requests and responses 1524 through an access point (e.g., cellular network tower) 1534. Some client endpoints 1510, such as autonomous vehicles may obtain network access for requests and responses 1526 via a wireless vehicular network through a street-located network system 1536. However, regardless of the type of network access, the TSP may deploy aggregation points 1542, 1544 within the edge cloud 1510 to aggregate traffic and requests, such as using edge cloud 1310 shown in FIG. 13 or using edge cloud 1410 shown in FIG. 14. Thus, within the edge cloud 1510, the TSP may deploy various compute and storage resources, such as at edge aggregation nodes 1540, to provide requested content. The edge aggregation nodes 1540 and other systems of the edge cloud 1510 are connected to a cloud or data center 1560, which uses a backhaul network 1550 to fulfill higher-latency requests from a cloud/data center for websites, applications, database servers, etc. Additional or consolidated instances of the edge aggregation nodes 1540 and the aggregation points 1542, 1544, including those deployed on a single server framework, may also be present within the edge cloud 1510 or other areas of the TSP infrastructure.

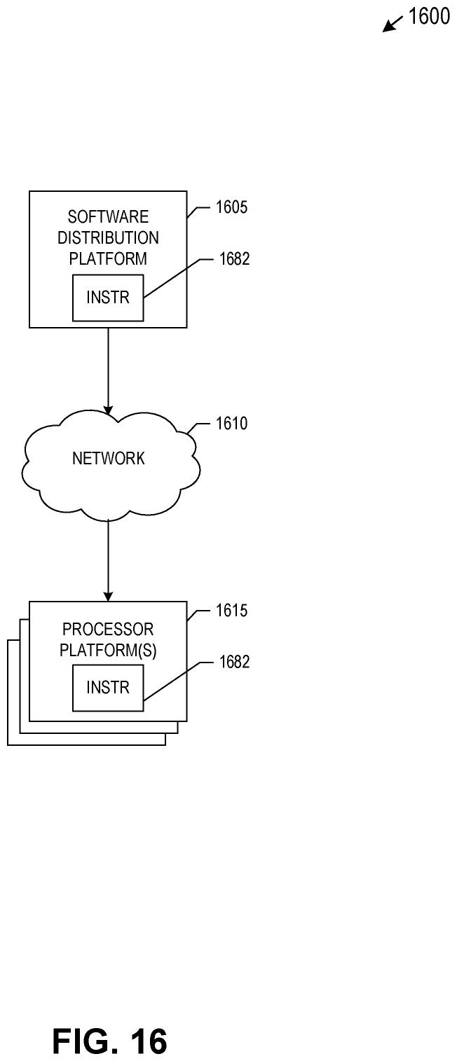

FIG. 16 illustrates an example software distribution platform 1605 to distribute software, according to an embodiment. The software distribution platform 1605 may include computer readable instructions 1682 (e.g., computer readable instructions 1282 of FIG. 12B), to one or more devices, such as example processor platform(s) 1615 and/or example connected edge devices 1411 of FIG. 14. The example software distribution platform 1605 may be implemented by any computer server, data facility, cloud service, etc., capable of storing and transmitting software to other computing devices (e.g., third parties, the example connected edge devices 1411 of FIG. 14). Example connected edge devices may be customers, clients, managing devices (e.g., servers), third parties (e.g., customers of an entity owning and/or operating the software distribution platform 1605). Example connected edge devices may operate in commercial and/or home automation environments. In some examples, a third party is a developer, a seller, and/or a licensor of software such as the example computer readable instructions 1682. The third parties may be consumers, users, retailers, OEMs, etc., that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 16, the software distribution platform 1605 includes one or more servers and one or more storage devices. The storage devices store the computer readable instructions 1682, which may correspond to the example computer readable instructions 1282 of FIG. 12B, as described above. The one or more servers of the example software distribution platform 1605 are in communication with a network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or via a third-party payment entity. The servers enable purchasers and/or licensors to download the computer readable instructions 1282 from the software distribution platform 1605. For example, the software may be downloaded to the example processor platform(s) 1615 (e.g., example connected edge devices), which is/are to execute the computer readable instructions 1682 to implement non-dominant resource management for edge multi-tenant applications. In some examples, one or more servers of the software distribution platform 1605 are communicatively connected to one or more security domains and/or security devices through which requests and transmissions of the example computer readable instructions 1682 must pass. In some examples, one or more servers of the software distribution platform 1605 periodically offer, transmit, and/or force updates to the software (e.g., computer readable instructions 1682) to ensure improvements, patches, updates, etc., are distributed and applied to the software at the end user devices.

In the illustrated example of FIG. 16, the computer readable instructions 1682 are stored on storage devices of the software distribution platform 1605 in a particular format. A format of computer readable instructions includes but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1282 stored in the software distribution platform 1605 are in a first format when transmitted to the example processor platform(s) 1615. In some examples, the first format is an executable binary in which particular types of the processor platform(s) 1615 can execute. However, in some examples, the first format is uncompiled code that requires one or more preparation tasks to transform the first format to a second format to enable execution on the example processor platform(s) 1615. For instance, the receiving processor platform(s) 1615 may need to compile the computer readable instructions 1682 in the first format to generate executable code in a second format that is capable of being executed on the processor platform(s) 1615. In still other examples, the first format is interpreted code that, upon reaching the processor platform(s) 1615, is interpreted by an interpreter to facilitate execution of instructions.

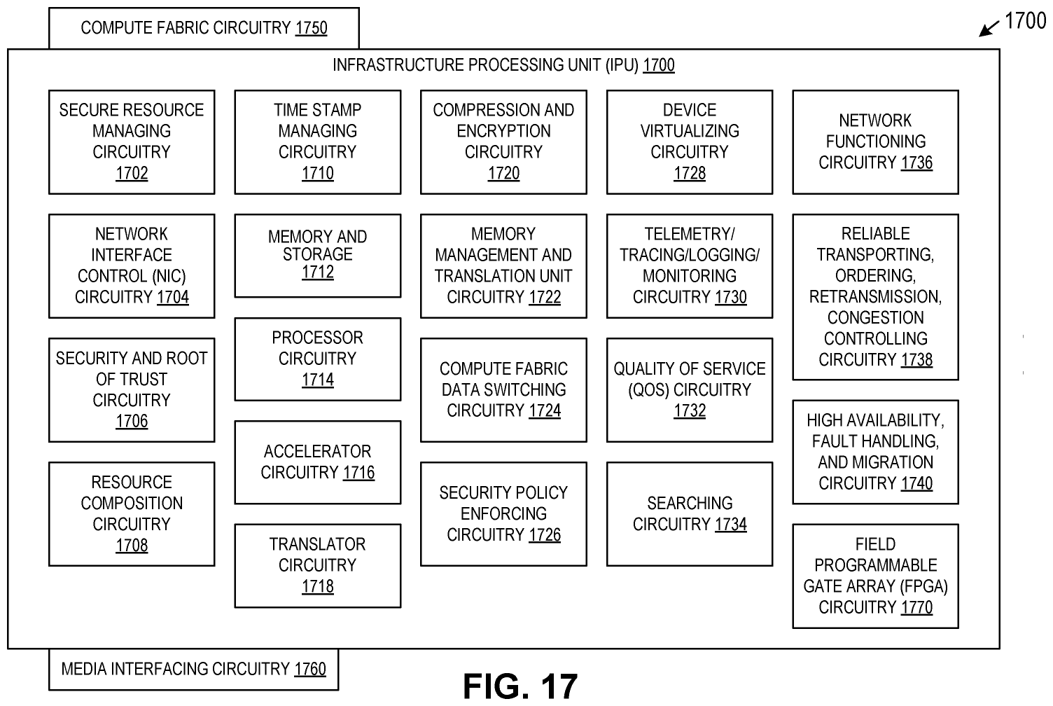

FIG. 17 depicts an example of an infrastructure processing unit (IPU). Different examples of IPUs disclosed herein enable improved performance, management, security, and coordination functions between entities (e.g., cloud service providers), and enable infrastructure offload or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes xPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 17, the IPU 1700 includes or otherwise accesses secure resource managing circuitry 1702, network interface controller (NIC) circuitry 1704, security and root of trust circuitry 1706, resource composition circuitry 1708, time stamp managing circuitry 1710, memory and storage 1712, processing circuitry 1714, accelerator circuitry 1716, or translator circuitry 1718. Any number or combination of other structure(s) can be used such as but not limited to compression and encryption circuitry 1720, memory management and translation unit circuitry 1722, compute fabric data switching circuitry 1724, security policy enforcing circuitry 1726, device virtualizing circuitry 1728, telemetry, tracing, logging and monitoring circuitry 1730, quality of service circuitry 1732, searching circuitry 1734, network functioning circuitry (e.g., routing, firewall, load balancing, network address translating (NAT), etc.) 1736, reliable transporting, ordering, retransmission, congestion controlling circuitry 1738, and high availability, fault handling and migration circuitry 1740 shown in FIG. 17. Different examples can use one or more structures (components) of the example IPU 1700 together or separately. For example, compression and encryption circuitry 1720 can be used as a separate service or chained as part of a data flow with vSwitch and packet encryption.

In some examples, IPU 1700 includes a field programmable gate array (FPGA) 1770 structured to receive commands from an CPU, xPU, or application via an API and perform commands/tasks on behalf of the CPU, including workload management and offload or accelerator operations. The illustrated example of FIG. 17 may include any number of FPGAs configured or otherwise structured to perform any operations of any IPU described herein.

Example compute fabric circuitry 1750 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, xPU, and IPU (e.g., via CXL.cache and CXL.mem).

Example media interfacing circuitry 1760 provides connectivity to a remote smartNIC or another IPU or service via a network medium or fabric. This can be provided over any type of network media (e.g., wired, wireless) and using any protocol (e.g., Ethernet, InfiniBand, Fiber channel, ATM, to name a few).

In some examples, instead of the server/CPU being the primary component managing IPU 1700, IPU 1700 is a root of a system (e.g., rack of servers or data center) and manages compute resources (e.g., CPU, xPU, storage, memory, other IPUs, and so forth) in the IPU 1700 and outside of the IPU 1700. Different operations of an IPU are described below.

In some examples, the IPU 1700 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 1700 is selected to perform a workload, secure resource managing circuitry 1702 offloads work to a CPU, xPU, or other device and the IPU 1700 accelerates connectivity of distributed runtimes, reduce latency, CPU and increases reliability.

In some examples, secure resource managing circuitry 1702 runs a service mesh to decide what resource is to execute workload, and provide for L7 (application layer) and remote procedure call (RPC) traffic to bypass kernel altogether so that a user space application can communicate directly with the example IPU 1700 (e.g., IPU 1700 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 1700 dynamically selects itself to run a given workload (e.g., microservice) within a composable infrastructure including an IPU, xPU, CPU, storage, memory, and other devices in a node.

In some examples, communications transit through media interfacing circuitry 1760 of the example IPU 1700 through a NIC/smartNlC (for cross node communications) or loopback back to a local service on the same host. Communications through the example media interfacing circuitry 1760 of the example IPU 1700 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 1700 prioritizes its processing to minimize the stalling of the requesting application. In some examples, the IPU 1700 schedules the prioritized message request issuing the event to execute a SQL query database and the example IPU constructs microservices that issue SQL queries and the queries are sent to the appropriate devices or services.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

Each of the following non-limiting examples may stand on its own, or may be combined in various permutations or combinations with one or more of the other examples.

Example 1 is a system for trust brokering as a service, the system comprising: an edge computing node; and a trust brokering service edge computing device to: receive a computing workload request from an application, the application configured to process secure data; identify a set of security requirements associated with the computing workload request; identify a security feature present in the set of security requirements but not provided by the edge computing node; identify an application execution environment, the application execution environment providing the security feature; and executing the computing workload request at the application execution environment.

In Example 2, the subject matter of Example 1 includes wherein the application execution environment includes a trust brokering service, the trust brokering service configured to provide two-sided trust-brokered mediation between the application and the application execution environment.

In Example 3, the subject matter of Example 2 includes wherein: the application execution environment is executed on a target edge device; and the trust brokering service provides a virtualized view of the application execution environment to the application.

In Example 4, the subject matter of Examples 1-3 includes, the trust brokering service edge computing device further to: generate a set of workload microservices based on the computing workload request; generate a secure information container based on the set of workload microservices; and migrate the secure information container to the application execution environment.

In Example 5, the subject matter of Examples 1-4 includes, the trust brokering service edge computing device further to generate an application execution environment, wherein the application execution environment includes a secure plugin to provide the security feature and a virtual device corresponding to the edge computing node.

In Example 6, the subject matter of Example 5 includes wherein the application execution environment includes at least one of an application sidecar, a logical network slice, or a scalable input/output virtualization (IOV).

In Example 7, the subject matter of Example 6 includes wherein the logical network slice includes a dynamically created logical network subset, the logical network slice associated with a set of logical network function instances and a set of logical network resources.

In Example 8, the subject matter of Examples 6-7 includes wherein the scalable IOV includes a set of dynamically reallocated logical network resources.

In Example 9, the subject matter of Example 8 includes wherein the set of dynamically reallocated logical network resources include at least one of logical compute resources, logical storage resources, and logical network communication resources.

In Example 10, the subject matter of Examples 1-9 includes wherein the application execution environment is implemented within a virtual execution environment.

In Example 11, the subject matter of Examples 1-10 includes wherein the virtual execution environment includes a virtual machine, the virtual machine emulating a physical compute device within a host machine.

In Example 12, the subject matter of Examples 1-11 includes wherein the virtual execution environment includes a virtual container, the virtual container including a virtual application and a set of application dependencies.

Example 13 is a method for trust brokering as a service, the method comprising: receiving, at a trust brokering service edge computing device, a computing workload request from an application, the application configured to process secure data; identifying a set of security requirements associated with the computing workload request; identifying a security feature present in the set of security requirements but not provided by an edge computing node; identifying an application execution environment, the application execution environment including a secure plugin providing the security feature and a virtual device corresponding to the edge computing node; and causing the computing workload request to be executed at the application execution environment.

In Example 14, the subject matter of Example 13 includes wherein the application execution environment includes a trust brokering service, the trust brokering service configured to provide two-sided trust-brokered mediation between the application and the application execution environment.

In Example 15, the subject matter of Example 14 includes wherein: the application execution environment is executed on a target edge device; and the trust brokering service provides a virtualized view of the application execution environment to the application.

In Example 16, the subject matter of Examples 13-15 includes, generating a set of workload microservices based on the computing workload request; generating a secure information container based on the set of workload microservices; and migrating the secure information container to the application execution environment.

In Example 17, the subject matter of Examples 13-16 includes, generating the application execution environment, wherein the application execution environment includes a secure plugin to provide the security feature and a virtual device corresponding to the edge computing node.

In Example 18, the subject matter of Example 17 includes wherein the application execution environment includes at least one of an application sidecar, a logical network slice, or a scalable input/output virtualization (IOV).

In Example 19, the subject matter of Example 18 includes wherein the logical network slice includes a dynamically created logical network subset, the logical network slice associated with a set of logical network function instances and a set of logical network resources.

In Example 20, the subject matter of Examples 18-19 includes wherein the scalable IOV includes a set of dynamically reallocated logical network resources.

In Example 21, the subject matter of Example 20 includes wherein the set of dynamically reallocated logical network resources include at least one of logical compute resources, logical storage resources, and logical network communication resources.

In Example 22, the subject matter of Examples 13-21 includes wherein the application execution environment is implemented within a virtual execution environment.

In Example 23, the subject matter of Examples 13-22 includes wherein the virtual execution environment includes a virtual machine, the virtual machine emulating a physical compute device within a host machine.

In Example 24, the subject matter of Examples 13-23 includes wherein the virtual execution environment includes a virtual container, the virtual container including a virtual application and a set of application dependencies.

Example 25 is a machine-readable storage medium comprising instructions that, when executed by a processor of a trust brokering service edge computing device, cause the trust brokering service edge computing device to: receive, at a trust brokering service edge computing device, a computing workload request from an application, the application configured to process secure data; identify a set of security requirements associated with the computing workload request; identify a security feature present in the set of security requirements but not provided by an edge computing node; identify an application execution environment, the application execution environment including a secure plugin providing the security feature and a virtual device corresponding to the edge computing node; and execute the computing workload request at the application execution environment.

In Example 26, the subject matter of Example 25 includes wherein the application execution environment includes a trust brokering service, the trust brokering service configured to provide two-sided trust-brokered mediation between the application and the application execution environment.

In Example 27, the subject matter of Example 26 includes wherein: the application execution environment is executed on a target edge device; and the trust brokering service provides a virtualized view of the application execution environment to the application.

In Example 28, the subject matter of Examples 25-27 includes, the instructions further causing the trust brokering service edge computing device to: generating a set of workload microservices based on the computing workload request; generating a secure information container based on the set of workload microservices; and migrating the secure information container to the application execution environment.

In Example 29, the subject matter of Examples 25-28 includes, the instructions further causing the trust brokering service edge computing device to generate the application execution environment, wherein the application execution environment includes a secure plugin to provide the security feature and a virtual device corresponding to the edge computing node.

In Example 30, the subject matter of Example 29 includes wherein the application execution environment includes at least one of an application sidecar, a logical network slice, or a scalable input/output virtualization (IOV).

In Example 31, the subject matter of Example 30 includes wherein the logical network slice includes a dynamically created logical network subset, the logical network slice associated with a set of logical network function instances and a set of logical network resources.

In Example 32, the subject matter of Examples 30-31 includes wherein the scalable IOV includes a set of dynamically reallocated logical network resources.

In Example 33, the subject matter of Example 32 includes wherein the set of dynamically reallocated logical network resources include at least one of logical compute resources, logical storage resources, and logical network communication resources.

In Example 34, the subject matter of Examples 25-33 includes wherein the application execution environment is implemented within a virtual execution environment.

In Example 35, the subject matter of Examples 25-34 includes wherein the virtual execution environment includes a virtual machine, the virtual machine emulating a physical compute device within a host machine.

In Example 36, the subject matter of Examples 25-35 includes wherein the virtual execution environment includes a virtual container, the virtual container including a virtual application and a set of application dependencies.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for trust brokering as a service, the system comprising:
an edge computing node; and
a trust brokering service edge computing device to:
receive a computing workload request from an application, the application configured to process secure data;
identify a set of security requirements associated with the computing workload request;
identify a security feature present in the set of security requirements but not provided by the edge computing node;
identify an application execution environment, the application execution environment providing the security feature; and
executing the computing workload request at the application execution environment.

2. The system of claim 1, wherein the application execution environment includes a trust brokering service, the trust brokering service configured to provide two-sided trust-brokered mediation between the application and the application execution environment.

3. The system of claim 2, wherein:
the application execution environment is executed on a target edge device; and
the trust brokering service provides a virtualized view of the application execution environment to the application.

4. The system of claim 1, the trust brokering service edge computing device further to:
generate a set of workload microservices based on the computing workload request;
generate a secure information container based on the set of workload microservices; and
migrate the secure information container to the application execution environment.

5. The system of claim 1, the trust brokering service edge computing device further to generate an application execution environment, wherein the application execution environment includes a secure plugin to provide the security feature and a virtual device corresponding to the edge computing node.

6. The system of claim 5, wherein the application execution environment includes at least one of an application sidecar, a logical network slice, or a scalable input/output virtualization (IOV).

7. The system of claim 6, wherein the logical network slice includes a dynamically created logical network subset, the logical network slice associated with a set of logical network function instances and a set of logical network resources.

8. The system of claim 1, wherein the application execution environment is implemented within a virtual execution environment.

9. A method for trust brokering as a service, the method comprising:
receiving, at a trust brokering service edge computing device, a computing workload request from an application, the application configured to process secure data;
identifying a set of security requirements associated with the computing workload request;
identifying a security feature present in the set of security requirements but not provided by an edge computing node;
identifying an application execution environment, the application execution environment including a secure plugin providing the security feature and a virtual device corresponding to the edge computing node; and
causing the computing workload request to be executed at the application execution environment.

10. The method of claim 9, wherein the application execution environment includes a trust brokering service, the trust brokering service configured to provide two-sided trust-brokered mediation between the application and the application execution environment.

11. The method of claim 10, wherein:
the application execution environment is executed on a target edge device; and
the trust brokering service provides a virtualized view of the application execution environment to the application.

12. The method of claim 9, further including:
generating a set of workload microservices based on the computing workload request;
generating a secure information container based on the set of workload microservices; and
migrating the secure information container to the application execution environment.

13. The method of claim 9, further including generating the application execution environment, wherein the application execution environment includes a secure plugin to provide the security feature and a virtual device corresponding to the edge computing node.

14. The method of claim 13, wherein the application execution environment includes at least one of an application sidecar, a logical network slice, or a scalable input/output virtualization (IOV).

15. The method of claim 14, wherein the logical network slice includes a dynamically created logical network subset, the logical network slice associated with a set of logical network function instances and a set of logical network resources.

16. A machine-readable storage medium comprising instructions that, when executed by a processor of a trust brokering service edge computing device, cause the trust brokering service edge computing device to:
receive, at a trust brokering service edge computing device, a computing workload request from an application, the application configured to process secure data;
identify a set of security requirements associated with the computing workload request;
identify a security feature present in the set of security requirements but not provided by an edge computing node;
identify an application execution environment, the application execution environment including a secure plugin providing the security feature and a virtual device corresponding to the edge computing node; and
execute the computing workload request at the application execution environment.

17. The machine-readable storage medium of claim 16, wherein the application execution environment includes a trust brokering service, the trust brokering service configured to provide two-sided trust-brokered mediation between the application and the application execution environment.

18. The machine-readable storage medium of claim 17, wherein:
the application execution environment is executed on a target edge device; and
the trust brokering service provides a virtualized view of the application execution environment to the application.

19. The machine-readable storage medium of claim 16, the instructions further causing the trust brokering service edge computing device to:
generating a set of workload microservices based on the computing workload request;
generating a secure information container based on the set of workload microservices; and
migrating the secure information container to the application execution environment.

20. The machine-readable storage medium of claim 16, the instructions further causing the trust brokering service edge computing device to generate the application execution environment, wherein the application execution environment includes a secure plugin to provide the security feature and a virtual device corresponding to the edge computing node.
